(19) United States
(12) Patent Application Publication
(10) Pub. No.: US 2012/0250166 A1
(43) Pub. Date: Oct. 4, 2012

(54) LIGHT-SHIELDING CURABLE COMPOSITION, WAFER LEVEL LENS AND LIGHT-SHIELDING COLOR FILTER

(76) Inventors: Hiroaki Idei, Haibara-gun (JP); Yushi Kaneko, Haibara-gun (JP); Kazuto Shimada, Haibara-gun (JP)

(21) Appl. No.: 13/516,596

(22) PCT Filed: Dec. 16, 2010
(86) PCT No.: PCT/JP2010/073260

§ 371 Date: Jun. 15, 2012

(30) Foreign Application Priority Data
Dec. 18, 2009 (JP) 2009-288122
Dec. 8, 2010 (JP) 2010-273801

(51) Int. Cl. G02B 5/23; G02B 5/22; G02B 3/00

(52) U.S. Cl. 359/722; 252/586; 359/885

(57) ABSTRACT

A light-shielding curable composition is provided which exhibits excellent dispersion property, excellent storage stability, and excellent pattern edge formability, and a wafer level lens and a light-shielding color filter which have a light-shielding section produced using the curable composition are provided. The light-shielding curable composition includes (A) an inorganic pigment; (B) a dispersant having a polyester structure; (C) a polymerizable compound having a polyester structure; (D) a polymerization initiator; and (E) a solvent.

### TECHNICAL FIELD

The present invention relates to a light-shielding curable composition, a wafer level lens and a light-shielding color filter.

### BACKGROUND ART

Recently, compact and low-profile (thin) imaging units have been mounted on mobile terminals of electronic instruments such as mobile phones or Personal Digital Assistants (PDAs). These imaging units generally include solid-state imaging devices such as an image sensor of a Charge Coupled Device (CCD) type or an image sensor of a Complementary Metal-Oxide Semiconductor (CMOS) type, and a lens for forming a subject image on the solid-state imaging devices.

With the reduction in size and thickness of the mobile terminals and with the widespread use of the mobile terminals, further reduction in the size and thickness of an imaging unit mounted on the mobile terminals is required and improvement in the productivity thereof is also required. With respect to such requirements, a method of mass-producing imaging units is known whereby a lens substrate having plural lenses formed thereon and a sensor substrate having plural solid-state imaging devices formed thereon are integrally combined, and the lens substrate and the sensor substrate are cut so as to include a lens and a solid-state imaging device in each cut portion.

In addition, adopting a method of forming a lens on a wafer enables various simple methods of formation to be carried out including, for example, a method where only lenses are produced on a glass wafer, for example, which is cut to a size for combination of the respective lenses with sensors, followed by combination with pre-separated imaging devices to produce respective imaging units; a method where plural lenses are formed from only a resin using a mold, which are combined on a sensor substrate and then cut; and a method where a lens is cut to a size for combination with respective sensors, followed by combination with pre-separated imaging devices, to produce respective imaging units.

As a wafer level lens array in the related art, a wafer level lens array is known that has plural lenses formed thereon by applying dropwise a curable resin material onto the surface of a parallel plate formed of a light transmissive material such as glass and curing the resin material in a state in which it is arranged in a prescribed shape using a mold (for example, see Japanese Patent Publication No. 3926380 and International Application Publication No. 2008/102648). In some cases, a light-shielding section formed, for example, from a light-shielding film or a metal film may be formed on a peripheral edge portion of the lens portion of a wafer level lens or on a part of the lens in order to control the amount of light passing therethrough. The light-shielding section is generally formed by coating a light-shielding curable composition and using a photolithography method or by depositing metals.

As another wafer level lens array, a wafer level lens array is also known that is obtained by forming plural through-holes on a silicon substrate, disposing spherical lens materials, which have been separately-formed, in the respective through-holes, bonding the lens materials to the substrate by soldering, and then polishing the lens materials to form plural lenses (see U.S. Pat. No. 6,426,829). In a lens obtained by this production method, the light-shielding film or the metal film described above may be formed in order to control the amount of light passing therethrough.

In order, for example, to shield light between colored pixels and improve contrast, a color filter used in a liquid crystal display has a light-shielding film that is known as a black matrix. Further, in order, for example, to prevent the occurrence of noise and improve image quality, a light-shielding color filter is provided in a solid-state imaging device.

In a case in which the light-shielding section of these wafer level lenses, a black matrix of a color filter for a liquid crystal display, or a light-shielding color filter for a solid-state imaging device is formed by a photolithography method using a photocurable composition containing a light-shielding material exhibiting a light-shielding property (hereinafter, also referred to as “light-shielding curable composition”), the following properties are required of the light-shielding curable composition. Specifically, it is required that a cured product of the light-shielding curable composition has a high light-shielding property, the light-shielding curable composition has an excellent developing property such that the uncured composition is removed easily and cleanly by a developer, and excellent formability of a pattern edge such that there is a sharp distinction at a boundary between a cured section and an uncured section.

For example, a blending ratio of the light-shielding material contained in the light-shielding curable composition may be increased, and thereby a cured film having a high light-shielding property is obtained. However, when a blending ratio of the light-shielding material is high, for example, a blending ratio of a component that contributes to the curing property or the developing property such as a polymerizable compound is lowered, and therefore the curing property, the developing property and formability of the pattern edge of the light-shielding curable composition are deteriorated. Further, when a blending ratio of a multifunctional monomer is increased in combination with an increase of a blending ratio of the light-shielding material, a curing property of the light-shielding curable composition is increased and, for example, sensitivity, hardness, strength, and adhesiveness of the light-shielding curable composition are improved, but a blending ratio of the multifunctional monomer is increased, and therefore the developing property of the light-shielding curable composition is further deteriorated. When the developing property of the light-shielding curable composition is deteriorated, problems such as deterioration of pattern edge formability or development residue become pronounced.

### DISCLOSURE OF INVENTION

The present invention has been made in view of the above problems, and an aspect of the invention is to provide a light-shielding curable composition which is capable of providing a cured film having a high light-shielding property, and exhibits an excellent developing property and excellent pattern edge formability.

Another aspect of the invention is to provide a wafer level lens having a light-shielding section having a high light-shielding property and an excellent pattern edge.

Still another aspect of the invention is to provide a light-shielding color filter with a light-shielding section having a high light-shielding property.

Specifically, exemplary embodiments of the invention are as follows.

<1> A light-shielding curable composition, comprising:

an inorganic pigment;

a dispersant having a polyester structure;

a polymerizable compound having a polyester structure;

a polymerization initiator; and

a solvent.

<2> The light-shielding curable composition according to <1>, wherein a value M/v, obtained by dividing the molecular weight (M) of the polymerizable compound having a polyester structure by the number (v) of polymerizable groups in a molecule of the polymerizable compound having a polyester structure, is in a range of from 100 to 3000.

<3> The light-shielding composition according to <1> or <2>, wherein the polymerizable compound having a polyester structure comprises polycaprolactone as the polyester structure.

<4> The light-shielding curable composition according to any one of <1> to <3>, wherein the inorganic pigment comprises titanium black.

<5> The light-shielding curable composition according to any one of <1> to <4>, wherein the dispersant having a polyester structure comprises a copolymer of a monomer having an acidic group having a pKa of 6 or less and a macromonomer which is represented by the following Formula (1) or Formula (2) and which has a mass average molecular weight of 1,000 or more:

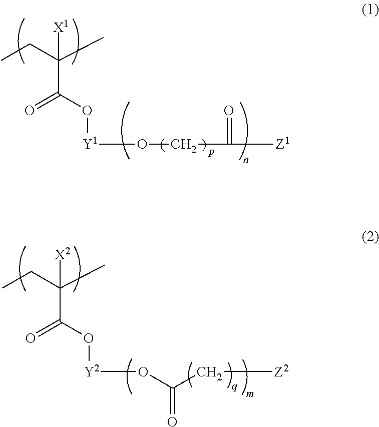

wherein, in Formulae (1) and (2), X¹ and X² each independently represent a hydrogen atom or a monovalent organic group; Y¹ and Y² each independently represent a divalent linking group; Z¹ and Z² each independently represent a monovalent organic group; n and m each independently represent an integer of 1 to 500; p and q each independently represent an integer of 2 to 5; and when n represents an integer of 2 or more, plural p's may be the same as or different from each other, and when m represents an integer of 2 or more, plural q's may be the same as or different from each other.

<6> The light-shielding curable composition according to any one of <1> to <4>, wherein the dispersant having a polyester structure comprises a resin represented by the following Formula (1):

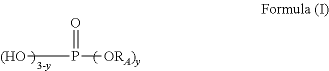

wherein, in Formula (1), R_{A} represents a polyester having a number average molecular weight of from 500 to 30,000; and y represents 1 or 2.

<7> The light-shielding composition according to any one of <1> to <6>, further comprising an organic pigment.

<8> The light-shielding curable composition according to any one of <1> to <7>, wherein a content of the inorganic pigment is from 6% by mass to 70% by mass with respect to a total solid content of the light-shielding curable composition.

<9> The light-shielding curable composition according to any one of <1> to <8>, wherein a content of the dispersant having a polyester structure is from 0.1% by mass to 50% by mass with respect to a total solid content of the light-shielding curable composition.

<10> The light-shielding curable composition according to any one of <1> to <9>, wherein a content of the polymerizable compound having a polyester structure is from 3% by mass to 55% by mass with respect to a total solid content of the light-shielding curable composition.

<11> The light-shielding curable composition according to any one of <1> to <10>, further comprising a binder polymer.

<12> A wafer level lens, comprising:

a substrate;

a lens; and

a light-shielding section formed at the circumference of the lens, the light-shielding section being formed by curing the light-shielding curable composition according to any one of <1> to <11>.

<13> A color filter, comprising:

a substrate; and

a light-shielding section on the substrate, the light-shielding section being formed by curing the light-shielding curable composition according to any one of <1> to <11>.

According to an aspect of the invention, a light-shielding curable composition which is capable of providing a cured film having a high light-shielding property and which exhibits an excellent developing property and pattern edge formability is provided. Moreover, according to another aspect of the invention, a wafer level lens with a light-shielding section having a high light-shielding property and an excellent pattern edge is provided. In addition, according to still another aspect of the invention, a light-shielding color filter with a light-shielding section having a high light-shielding property is provided.

### BRIEF DESCRIPTION OF DRAWINGS

FIG. 1 is a plan view showing an example of a wafer level lens array;

FIG. 2 is a cross-sectional view of the wafer level lens array shown in FIG. 1, which is taken along the line A-A;

FIG. 3 is a schematic view showing the state of supplying a molding material for forming a lens on a substrate;

FIGS. 4A to 4C are schematic views showing the process of forming lenses on a substrate by a mold;

FIGS. 5A to 5C are schematic views showing the process of forming a patterned light-shielding film of the light-shielding curable composition of the invention on the substrate where lenses have been formed;

FIG. 6 is a cross-sectional view showing another configuration example of a wafer level lens array;

FIGS. 7A to 7C are schematic views showing another embodiment of the process of forming a light-shielding film using the light-shielding curable composition of the invention;

FIGS. 8A to 8C are schematic views showing the process of forming lenses on a substrate having a patterned light-shielding layer formed by the light-shielding curable composition of the invention.

### DESCRIPTION OF EMBODIMENTS

The light-shielding curable composition of the invention will be described in detail below.

In the present specification, a “wafer level lens” refers to a lens provided in a solid-state imaging device and includes one of plural lenses present on a substrate and a light-shielding section provided at a peripheral portion of the lens. Further, a group of wafer level lenses is called a “wafer level lens array”.

### Light-Shielding Curable Composition

The light-shielding curable composition of the invention includes an (A) inorganic pigment, a (B) dispersant having a polyester structure, a (C) polymerizable compound having a polyester structure, a (D) polymerization initiator and a (E) solvent.

(A) Inorganic Pigment

As a light-shielding material contained in the light-shielding curable composition of the invention, an (A) inorganic pigment is selected from the viewpoints of storage stability and safety. The (A) inorganic pigment is preferably a pigment having absorbance in a wavelength region from ultraviolet to infrared light, in order to express a light-shielding property in a wavelength range from ultraviolet to infrared light. Examples of the (A) inorganic pigment include a pigment consisting of a single metal, and a pigment consisting of a metal compound selected from a metal oxide, a metal complex salt, and the like.

Specific examples of the inorganic pigment include Chinese white, lead white, lithopone, titanium oxide, chromium oxide, iron oxide, precipitated barium sulfate and baryte powder, red lead, iron oxide red, chrome yellow, zinc chromate (such as zinc potassium chromate, and zinc tetroxy chromate), ultramarine blue, Prussian blue (potassium ferric ferrocyanide), zircon gray, praseodymium yellow, chrome titanium yellow, chrome green, peacock, Victoria green, iron blue (having no relation with Prussian blue), vanadium zirconium blue, chrome tin pink, manganese pink, and salmon pink. Examples of black inorganic pigments include a metal oxide and a metal nitride containing one or two or more kinds of metal elements selected from the group consisting of Co, Cr, Cu, Mn, Ru, Fe, Ni, Sn, Ti, and Ag. These pigments may be used alone or in a mixture of two or more kinds.

In particular, these pigments can be used not only alone but also in a mixture of plural kinds of pigments, in order to express a light-shielding property in a wide wavelength region from ultraviolet to infrared light.

From the viewpoints of light-shielding property and curing property, a metal pigment containing at least one of silver and tin, and titanium black are preferred. From the viewpoints of a light-shielding property in a range from ultraviolet to infrared light, titanium black is most preferred.

The titanium black used in the invention is a black particle having a titanium atom. Preferable examples thereof include low order titanium oxide and titanium oxynitride. A titanium black particle may be used as it is, or the surface thereof may be optionally modified from the viewpoints of, for example, improvement of dispersibility and suppression of aggregating property. The titanium black particle may be coated with silicon oxide, titanium oxide, germanium oxide, aluminum oxide, magnesium oxide, or zirconium oxide. Alternatively, the titanium black particle may be treated with a water repellent material as described in Japanese Patent Application Laid-Open (JP-A) No. 2007-302836.

Further, the titanium black may contain one or a combination of two or more kinds of a composite oxide of Cu, Fe, Mn, V, Ni, and the like and a black pigment such as cobalt oxide, iron oxide, carbon black, or aniline black, in order to adjust dispersibility and colorability. In this case, the titanium black particle accounts for 50% by mass or more in the (A) inorganic pigment.

Examples of the commercial product of titanium black include, for example, titanium black 10S, 12S, 13R, 13M, 13M-C, 13R and 13R—N (trade names, manufactured by Mitsubishi Material Corporation) and TILACK D (trade name, manufactured by Ako Kasei Co., Ltd.).

The titanium black may be produced by, for example, a method where a mixture of titanium dioxide and metal titanium is heated and reduced in a reducing atmosphere (see, for example, JP-A No. 49-5432), a method where titanium tetrachloride is hydrolyzed at high temperature to obtain ultrafine titanium dioxide and the obtained titanium dioxide is reduced in a reducing atmosphere containing hydrogen (see, for example, JP-A No. 57-205322), a method where titanium dioxide or titanium hydroxide is reduced at high temperature in the presence of ammonia (see, for example, JP-A No. 60-65069, JP-A No. 61-201610), and a method where a vanadium compound is adhered to titanium dioxide or titanium hydroxide and the resultant is then reduced at high temperature in the presence of ammonia (see, for example, JP-A No. 61-201610), but the invention is not limited thereto.

A specific area of the titanium black is not specifically limited. However, in order that a water repellent property has a prescribed performance after the titanium black is surface-treated by a water repellent agent, it is preferred that the titanium black has a surface area measured by the BET method of generally from about 5 m²/g to 150 m²/g, and preferably from about 20 m²/g to 100 m²/g.

The (A) inorganic pigment used in the invention, which is typified by titanium black, preferably has an average primary particle diameter of from 5 nm to 10 μm. From the viewpoints of dispersibility, a light-shielding property, and a precipitation property over time, the average primary particle diameter is preferably from 10 nm to 1 pm. An inorganic pigment particle may have any shape such as a spherical shape, a flat plate shape, a needle shape, or a spindle shape. The particle diameter of the inorganic pigment may be obtained by taking TEM (transmission electron microscope) images. Specifically, profile areas of 100 or more inorganic pigment particles are obtained using a TEM, equivalent circle diameters of the inorganic pigment particles are then obtained, and then the arithmetic average of the circle equivalent diameters is calculated, which is defined as the average primary particle size.

In the light-shielding curable composition of the invention, the (A) inorganic pigment may be used alone or in combination of two or more kinds. Further, as described below, an organic pigment or dye may be used in combination with the inorganic pigment if necessary, in order to adjust a light-shielding property and color tone.

The content of the (A) inorganic pigment (or the total content of the (A) inorganic pigments when two or more kinds thereof are used) in the light-shielding curable composition is preferably from 5% by mass to 70% by mass, and more preferably from 10% by mass to 50% by mass, with respect to the total solid content.

When the (A) inorganic pigment is to be blended into the light-shielding curable composition, it is preferable that the inorganic pigment is previously dispersed using the (B) dispersant having a polyester structure to prepare a pigment dispersion, and then the pigment dispersion is blended with the light-shielding curable composition, because it is easy to homogeneously disperse the inorganic pigment.

Next, the (B) dispersant having a polyester structure will be described below.

(B) Dispersant Having a Polyester Structure

The (B) dispersant having a polyester structure (hereinafter, also referred to as (B) specific resin) used in the invention has at least a polyester structure. Therefore, dispersibility and storage stability are improved. This is considered to be because compatibility of polyester chain with solvent is good.

It is preferable that the (B) specific resin of the invention is: a (B-1) copolymer of a monomer (b-1) having an acidic group having a pKa of 6 or less and a macromonomer (b-2) having a mass average molecular weight of 1,000 or more; or (B-2) a dispersion resin represented by the following Formula (1), from the viewpoints of excellent performance where the (A) inorganic pigment is homogeneously and stably dispersed for a long time, and achieving a good developing property. It is described in detail below.

(B-1) Copolymer of Monomer (b-1) Having Acidic Group Having pKa of 6 or Less and Macromonomer (b-2) Having Mass Average Molecular Weight of 1,000 or More

Examples of the monomer (b-1) having an acidic group having a pKa of 6 or less include acrylic acid, methacrylic acid, p-styrene carboxylic acid, p-styrene sulfonic acid, vinyl phosphonic acid, vinyl sulfonic acid, ester of methacrylic acid and 2-hydroxyethyl monosuccinate, ester of methacrylic acid and 2-hydroxyethyl monophthalate, ester of methacrylic acid and 2-hydroxyethyl monophosphate, and 2-acrylamido-2-methyl propanesulfonic acid.

Examples of the macromonomer (b-2) having a mass average molecular weight of 1,000 or more include a compound represented by the following Formulae (1) or (2).

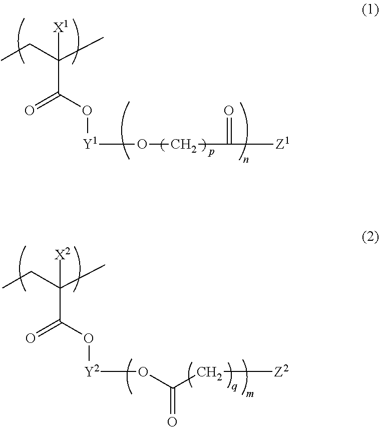

In Formulae (1) and (2), X¹ and X² each independently represent a hydrogen atom or a monovalent organic group. From the viewpoints of the restriction of synthesis, X¹ and X² each independently represent preferably a hydrogen atom or an alkyl group having 1 to 12 carbon atoms, more preferably a hydrogen atom or a methyl group, and particularly preferably a methyl group.

In Formulae (1) and (2), Y¹ and Y² each independently represent a divalent linking group and is not specifically limited from the viewpoints of structure. Specifically, examples of Y¹ and Y² include the following linking groups (Y-1) to (Y-20). In the following structures, A indicates the binding with a left terminal group in Formulae (1) and (2), and B indicates the binding with a right terminal group in Formulae (1) to (2) respectively. Among the structures shown below, it is preferred that Y¹ and Y² are each (Y-2) or (Y-13) from the viewpoints of easy synthesis.

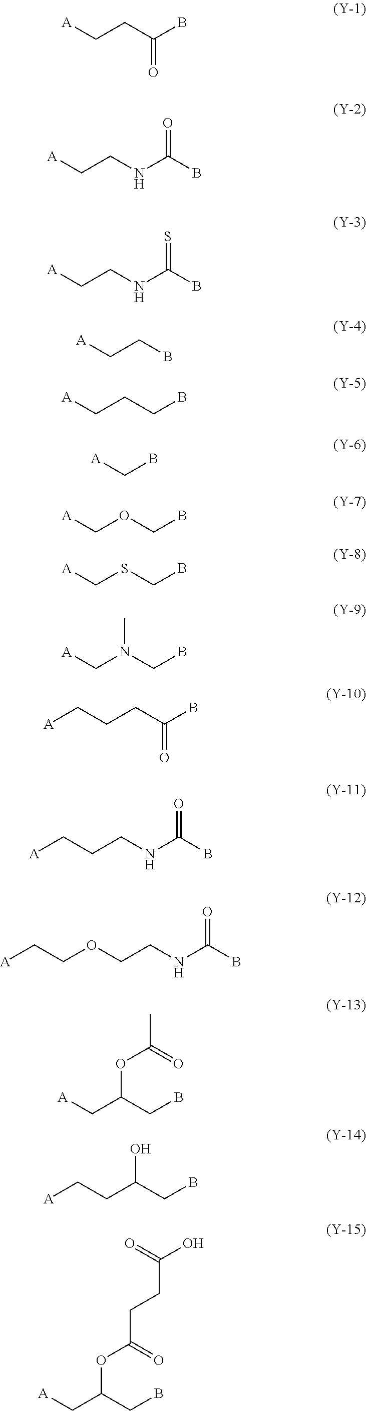

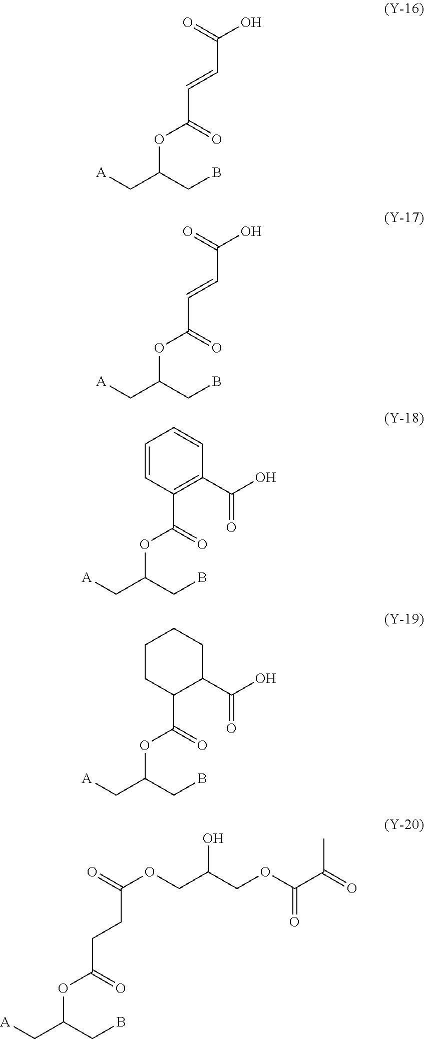

In Formulae (1) and (2), Z¹ and Z² each independently represent a monovalent organic group, of which structure is not specifically limited. Examples of the monovalent organic group represented by Z¹ or Z² include a hydroxyl group, an alkoxy group, an aryloxy group, a heteroaryloxy group, an alkylthio group, an arylthio group, a heteroarylthio group and an amino group. Among them, it is preferred that the monovalent organic group exhibit a steric repulsion effect from the viewpoints of the improvement of dispersibility, and is preferably an alkoxy group having 5 to 24 carbon atoms.

In Formulae (1) and (2), n and m each independently represent an integer of from 1 to 500, and from the viewpoints of dispersion stability and developability, n and m each independently represent preferably an integer of from 5 to 60, more preferably an integer of from 5 to 40, and further more preferably an integer of from 5 to 20. In Formulae (1) and (2), p and q each independently represent an integer of from 2 to 8, and from the viewpoints of dispersion stability and developability, p and q each independently represent preferably an integer of from 4 to 6, and most preferably represent 5.

When n represents an integer of 2 or more, plural p's may be the same as or different from each other, that is, plural structures shown in the parenthesis defined by n in Formula (1) may be the same as or different from each other. When m represents an integer of 2 or more, plural q's may be the same as or different from each other, that is, plural structures shown in the parenthesis defined by m in Formula (2) may be the same as or different from each other.

As a macromonomer, a combination of two or more compounds represented by Formula (1) in which n's represent different integers from one another, or a combination of two or more compounds each represented by Formula (2) in which m's represent different integers from one another, may be used. Furthermore, mixtures of the compounds represented by Formula (1) or (2) having different p's or q's may be used.

From the viewpoints of solubility in a dispersion solution, dispersibility in a dispersion solution and developing property, it is preferable to use a resin having a polycaprolactone side chain as a polyester chain (i.e., as the polyester structure), and having an acid group derived from carboxylic acid, sulfonic acid, or phosphoric acid.

The (B-1) copolymer of a monomer (b-1) having an acidic group having a pKa of 6 or less and a macromonomer (b-2) having a mass average molecular weight of 1,000 or more may further contain a repetition unit derived from a vinyl monomer (b-3) of other copolymerizable structures as long as the effect of the invention is not impaired.

The vinyl monomer that can be used herein is not specifically limited, and preferable examples thereof include (meth)acrylic acid esters, (meth)acrylamides, vinyl ethers, styrenes, and (meth)acrylonitriles. Specific examples of such vinyl monomers include the following compounds. In the present specification, “(meth)acryl”, “(meth)acrylic” and the like refer to either or both of “acryl” and “methacryl”.

Examples of the (meth)acrylic acid esters include methyl(meth)acrylate, ethyl(meth)acrylate, n-propyl(meth)acrylate, isopropyl(meth)acrylate, n-butyl(meth)acrylate, isobutyl(meth)acrylate, t-butyl(meth)acrylate, n-hexyl(meth)acrylate, cyclohexyl(meth)acrylate, t-butylcyclohexyl(meth)acrylate, 2-ethylhexyl(meth)acrylate, t-octyl(meth)acrylate, dodecyl(meth)acrylate, octadecyl(meth)acrylate, acetoxyethyl(meth)acrylate, phenyl(meth)acrylate, 2-hydroxyethyl(meth)acrylate, 2-methoxyethyl(meth)acrylate, 2-ethoxyethyl(meth)acrylate, 2-(2-methoxyethoxy)ethyl(meth)acrylate, 3-phenoxy-2-hydroxypropyl(meth)acrylate, benzyl(meth)acrylate, diethylene glycol monomethyl ether(meth)acrylate, diethylene glycol monoethyl ether(meth)acrylate, triethylene glycol monomethyl ether(meth)acrylate, triethylene glycol monoethyl ether(meth)acrylate, polyethylene glycol monomethyl ether(meth)acrylate, polyethylene glycol monoethyl ether(meth)acrylate, β-phenoxy ethoxy ethyl(meth)acrylate, nonylphenoxy polyethylene glycol (meth)acrylate, dicyclopentenyl(meth)acrylate, dicyclopentenyloxy ethyl (meth)acrylate, trifluoroethyl(meth)acrylate, octafluoropentyl(meth)acrylate, perfluorooctyl ethyl(meth)acrylate, dicyclopentanyl(meth)acrylate, tribromophenyl(meth)acrylate and tribromophenyloxy ethyl(meth)acrylate.

Examples of (meth)acrylamides include (meth)acrylamide, N-methyl(meth)acrylamide, N-ethyl(meth)acrylamide, N-propyl(meth)acrylamide, N-isopropyl(meth)acrylamide, N-n-butyl(meth)acrylamide, N-t-butyl(meth)acrylamide, N-cyclohexyl(meth)acrylamide, N-(2-methoxyethyl)(meth)acrylamide, N,N-dimethyl(meth)acrylamide, N,N-diethyl(meth)acrylamide, N-phenyl(meth)acrylamide, N-benzyl(meth)acrylamide, (meth)acryloyl morpholine and diacetone acrylamide.

Examples of vinyl ethers include methyl vinyl ether, butyl vinyl ether, hexyl vinyl ether and methoxy ethyl vinyl ether.

Examples of styrenes include styrene, methyl styrene, dimethyl styrene, trimethyl styrene, ethyl styrene, isopropyl styrene, butyl styrene, hydroxy styrene, methoxy styrene, butoxy styrene, acetoxy styrene, chloro styrene, dichloro styrene, bromo styrene, chloromethyl styrene, hydroxy styrene protected with a group (such as t-Boc) de-protectable by an acidic material, methyl vinyl benzoate and α-methyl styrene.

The copolymer (B-1) preferably contains the monomer (b-1) in an amount of from 3% by mass to 70% by mass, and more preferably from 5% by mass to 50% by mass, with respect to the total mass of thereof. The copolymer (B-1) preferably contains the macromonomer (b-2) in an amount of from 30% by mass to 97% by mass, and more preferably from 40% by mass to 95% by mass, with respect to the total mass thereof. When the amounts are within the above ranges, a light-shielding curable composition which has excellent compatibility to the (C) polymerizable compound having a polyester structure and exhibits an excellent developing property is obtained.

The mass average molecular weight of the copolymer (B-1) used in the invention is preferably from 10,000 to 300,000, more preferably from 15,000 to 200,000, even more preferably from 20,000 to 100,000 and particularly preferably from 25,000 to 50,000, from the viewpoints that a light-shielding curable composition in which the (A) inorganic pigment is dispersed homogeneously and stably is obtained and a good developing property is obtained. The mass average molecular weight of the specific resin can be measured by, for example, GPC.

(B-2) Resin Represented by Formula (1)

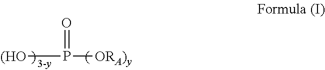

In Formula (1), R_{A} represents a polyester having a number average molecular weight of 500 to 30,000; and y represents 1 to 2. When y represents 2, plural R_{A}'s may be the same as or different from each other.

The dispersant represented by Formula (I) can be produced by a known method (for example, see JP-A No. 3-112992), and specifically, can be produced by reacting a polyester having a hydroxyl group at an end thereof with a phosphoric acid anhydride or poly-phosphoric acid. As the polyester, a polyester obtained by ring-opening polymerization of lactones is preferred from the viewpoints of solubility in the dispersion solution, dispersibility in the dispersion solution, and/or developing property. Among them, poly ε-caprolactone is most preferred.

The number average molecular weight of R_{A} is preferably from 500 to 30,000, more preferably from 500 to 20,000 and most preferably from 500 to 10,000.

The mass average molecular weight of the (B-2) resin is preferably from 500 to 30,000, more preferably from 500 to 20,000 and most preferably from 500 to 10,000. When the mass average molecular weight is within the above ranges, dispersion stability and developing property on a substrate are improved.

The (B-2) resin is obtained as a mixture of phosphoric acid monoester (in Formula (I), y=1) and phosphoric acid diester (in Formula (I), y=2). The ratio (phosphoric acid monoester/phosphoric acid diester) of phosphoric acid monoester and phosphoric acid diester is preferably from 95/5 to 65/35 in terms of molar ratio, and most preferably from 95/5 to 75/25. When the ratio is within the above ranges, dispersion stability is improved. The ratio of phosphoric acid monoester and phosphoric acid diester can be determined, for example, by ³¹P NMR spectrometry described in PCT Japanese Translation Patent Publication (JP-B) No. 2003-533455.

Hereinafter, specific structures of the specific resin (B) used in the invention are shown, but the invention is not limited thereto.

| | |
|---|---|
| | (B-1-1) |
| 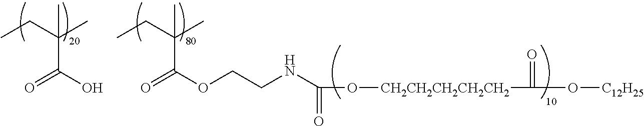 | |
| | (B-1-2) |
| 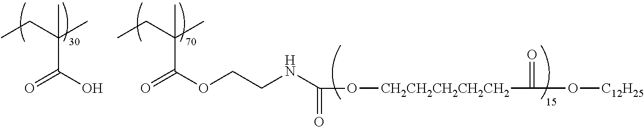 | |
| | (B-1-3) |
| 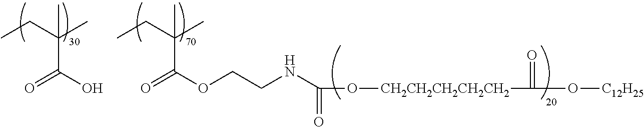 | |
| | (B-1-4) |
| 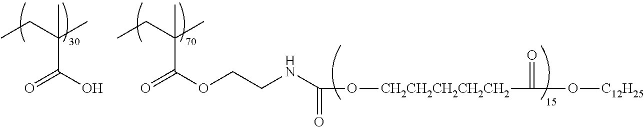 | |
| | (B-1-5) |
| 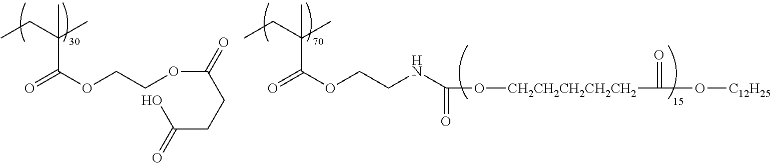 | |
| | (B-1-6) |
| 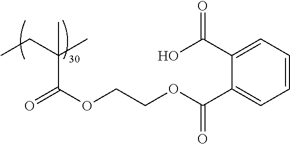 | |
| 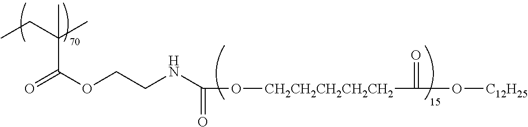 | |
| | (B-1-7) |
| 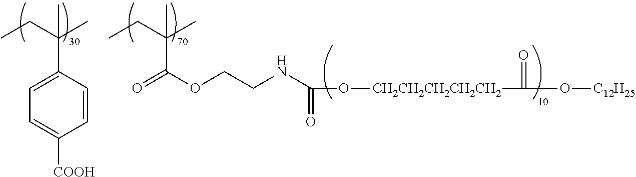 | |
| | (B-1-8) |
| 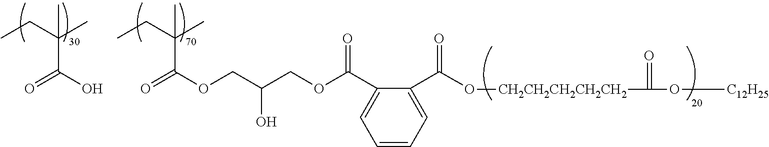 | |
| | (B-1-9) |
| 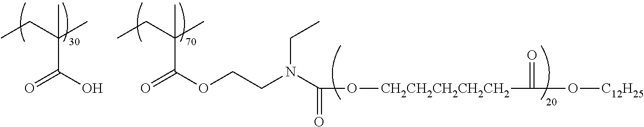 | |
| | (B-1-10) |
| 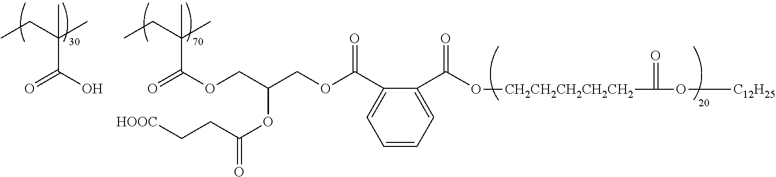 | |
| | (B-1-11) |
| 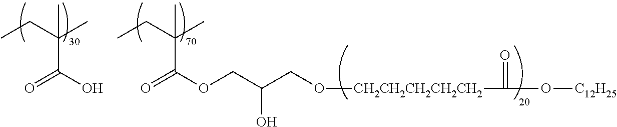 | |
| | (B-1-12) |
| 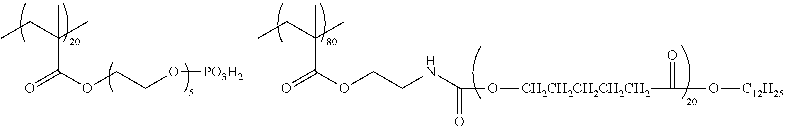 | |
| | (B-1-13) |
| 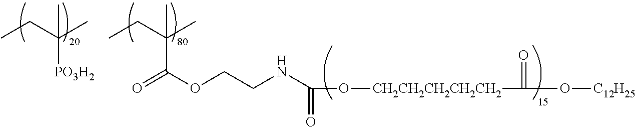 | |
| | (B-1-14) |
| 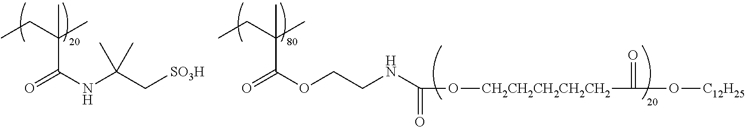 | |
| | (B-1-15) |
| 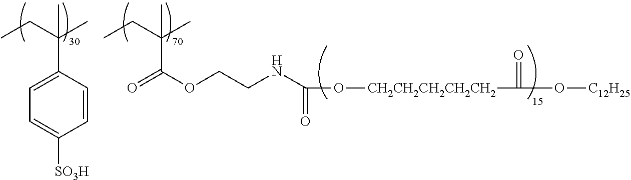 | |
| | (B-1-16) |
| 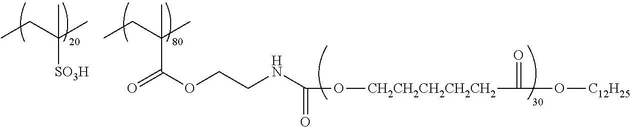 | |
| | (B-1-17) |
| 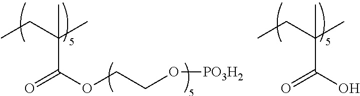 | |
| 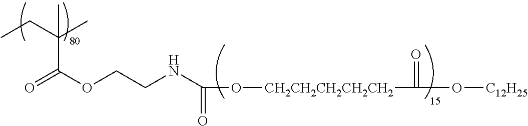 | |
| | (B-1-18) |
| 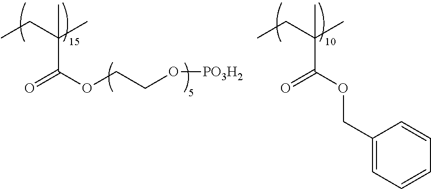 | |
| 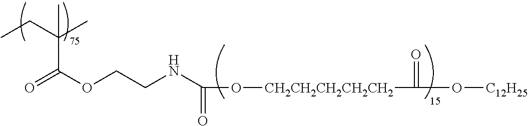 | |
| | (B-1-19) |
| 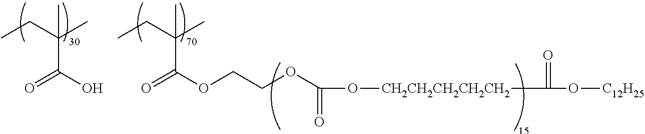 | |
| | (B-1-20) |
| 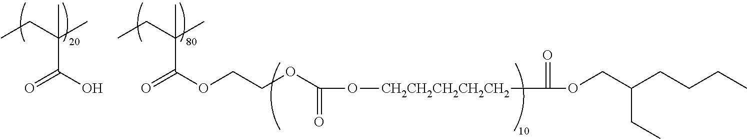 | |
| | (B-1-21) |
| 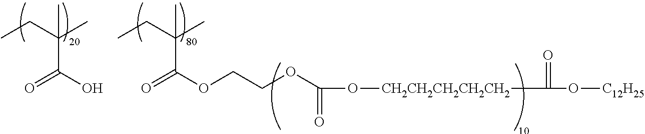 | |
| | (B-1-22) |
| 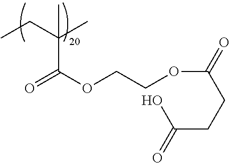 | |
| 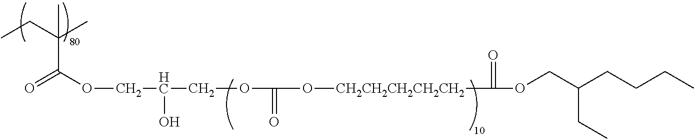 | |
| | (B-1-23) |
| 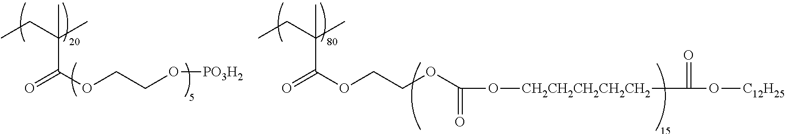 | |
| | (B-1-24) |
| 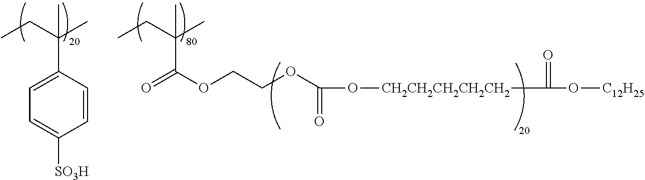 | |

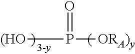

| | OR_{A} | y = 1:y = 2 |
|---|---|---|
| (B-2-1) | 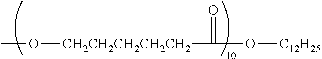 | 88:12 |
| (B-2-2) | 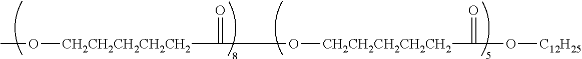 | 92:8 |
| (B-2-3) | 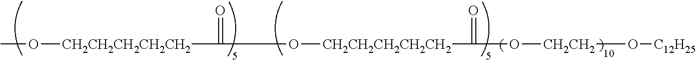 | 82:18 |

An acid value of the (B) specific resin used in the invention is preferably in a range of from 5.0 mgKOH/g to 250 mgKOH/g, more preferably in a range of from 15 mgKOH/g to 220 mgKOH/g, and even more preferably in a range of from 30 mgKOH/g to 200 mgKOH/g. When the acid value is 250 mgKOH/g or less, pattern peeling during development is suppressed, and when the acid value is 5.0 mgKOH/g or more, the alkali developing property is good.

In the light-shielding curable composition of the invention, the (A) inorganic pigment may be dispersed using the (B) specific resin and, optionally, another pigment dispersant (hereinafter, simply referred to as “combined dispersant”). Examples of the combined dispersant which can be used include one suitably selected from known pigment dispersants and surfactants, other than the (B) specific resin.

The combined dispersant is preferably a high molecular compound having a hetero-ring in a side chain thereof. The high molecular compound is preferably a polymer containing a polymerization unit derived from the monomer represented by formula (1) described in JP-A No. 2008-266627 or a monomer including maleimide or maleimide derivatives. The polymer is described in detail in paragraphs [0020] to [0047] of JP-A No. 2008-266627, and the polymer described herein can be preferably used in the invention as the combined dispersant.

As other combined dispersants, commercially available dispersants or surfactants can be used. Specific examples of the commercial product which can be used as the combined dispersant include: cationic surfactants such as organosiloxane polymer KP341 (trade names) (manufactured by Shin-Etsu Chemical Co., Ltd.), (meth)acrylic acid (co)polymer POLYFLOW No. 75, No. 90, No. 95 (trade names) (manufactured by Kyoeisha Chemical Co., Ltd.), or W001 (trade names) (available from Yusho Co., Ltd.); nonionic surfactants such as polyoxyethylene lauryl ether, polyoxyethylene stearyl ether, polyoxyethylene oleyl ether, polyoxyethylene octyl phenyl ether, polyoxyethylene nonyl phenyl ether, polyethylene glycol dilaurate, polyethylene glycol distearate, or sorbitan fatty acid ester; anionic surfactants such as WO04, WO05, or WO17 (trade names) (manufactured by Yusho Co., Ltd.); polymeric dispersants such as EFKA-46, EFKA-47, EFKA-47EA, EFKA POLYMER 100, EFKA POLYMER 400, EFKA POLYMER 401, EFKA POLYMER 450 (trade name) (manufactured by Ciba Specialty Chemicals), DISPERSE AID 6, DISPERSE AID 8, DISPERSE AID 15, or DISPERSE AID 9100 (trade names) (manufactured by San Nopco Limited); various SOLSPERSE dispersants such as SOLSPERSE 3000, 5000, 9000, 12000, 13240, 13940, 17000, 24000, 26000, 28000, 32000 or 36000 (trade names) (manufactured by The Lubrizol Corporation); ADEKA PLURONIC L31, F38, L42, L44, L61, L64, F68, L72, P95, F77, P84, F87, P94, L101, P103, F108, L121, P-123 (trade names) (manufactured by Asahi Denka Company Limited); IONET S-20 (trade name) (manufactured by Sanyo Chemical Industries, Ltd.); and DISPERBYK 101, 103, 106, 108, 109, 111, 112, 116, 130, 140, 142, 162, 163, 164, 166, 167, 170, 171, 174, 176, 180, 182, 2000, 2001, 2050, 2150 (trade names) (manufactured by BYK-Chemie).

In addition, other preferable examples of the combined dispersant include oligomers and polymers having a polar group at an end or a side chain of the molecules, such as acrylic copolymers.

The content of the (B) specific resin contained in the light-shielding curable composition of the invention is preferably in a range of from 0.1% by mass to 50% by mass with respect to the total solid content of the light-shielding curable composition, from the viewpoints that the (A) inorganic pigment is dispersed homogeneously and stably in the composition and a good developing property is obtained. The content of the (B) specific resin is more preferably in a range of from 5% by mass to 40% by mass, and yet more preferably in a range of from 10% by mass to 30% by mass, with respect to the total solid content of the light-shielding curable composition.

The amount of the (B) specific resin contained in the light-shielding curable composition of the invention is preferably in a range of from 15% by mass to 90% by mass with respect to the (A) inorganic pigment, from the viewpoint that the (A) inorganic pigment is dispersed homogeneously and stably in the light-shielding curable composition. The amount of the (B) specific resin is more preferably in a range of from 20% by mass to 70% by mass with respect to the (A) inorganic pigment.

In a case in which the combined dispersant other than the (B) specific resin is used, it is preferred that the amount of the combined dispersant to be used is in a range of from 30% by mass to 300% by mass with respect to the (B) specific resin.

(C) Polymerizable Compound Having Polyester Structure

The (C) polymerizable compound having a polyester structure (hereinafter, also referred to as (C) specific polymerizable compound) used in the invention contains at least a polyester structure and is an addition polymerizable compound having at least one ethylenic unsaturated double bond.

In view of the fact that a cured portion of the light-shielding curable composition of the invention has a sufficient degree of hardness while an uncured portion thereof has an eluting property such the uncured portion is easily eluted into a developing liquid, a value (M/v) obtained by dividing the molecular weight (M) of the (C) specific polymerizable compound by the number (v) of polymerizable groups in a molecule thereof is preferably from 100 to 3,000, more preferably from 150 to 2,000 and most preferably from 200 to 1,500.

The polyester structure contained in the (C) specific polymerizable compound is preferably a polyester structure obtained by ring-opening polymerization of a lactone. The polymerizable compound having a caprolacone structure is not particularly limited, as long as it has a caprolactone structure in a molecule thereof. Examples thereof include ε-caprolactone-modified polyfunctional (meth)acrylates which are obtained by esterification of a (meth)acrylic acid, ε-caprolactone, and a polyhydric alcohol such as trimethylolethane, ditrimethylolethane, trimethylolpropane, ditrimethylolpropane, pentaerythritol, dipentaerythritol, tripentaerythritol, glycerin, diglycerol, or trimethylolmelamine. In particular, polymerizable compounds having a caprolactone structure represented by the following Formula (11) is preferable.

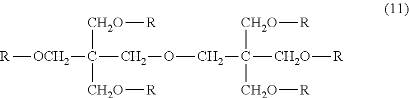

In Formula (11), all of six R's represent a group represented by the following Formula (12), or 1 to 5 of six R's represent/represents a group represented by the following Formula (12) and the remainder thereof represents a group represented by the following Formula (13).

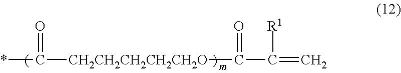

In Formula (12), R¹ represents a hydrogen atom or a methyl group; m represents 1 or 2; and “*” indicates a biding position in Formula (11).

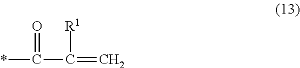

In Formula (13), R′ represents a hydrogen atom or a methyl group; and “*” indicates a binding.

The polymerizable compounds having such a caprolactone structure may be commercially available as KAYARAD DPCA series from Nippon Kayaku Co., Ltd., and examples thereof include KAYARAD DPCA-20 (in Formulae (11) to (13), m=1; the number of groups represented by Formula (12)=2; and all R¹'s represent a hydrogen atom), KAYARAD DPCA-30 (in Formulae (11) to (13), m=1; the number of groups represented by Formula (12)=3; and all R¹'s represent a hydrogen atom), KAYARAD DPCA-60 (in Formulae (11) to (13), m=1; the number of groups represented by Formula (12)=6; and all R¹'s represent a hydrogen atom), and KAYARAD DPCA-120 (in Formulae (11) to (13), m 2; the number of groups represented by Formula (12)=6; and all R¹'s represent a hydrogen atom). In the invention, polymerizable compounds having a caprolactone structure may be used singly, or in combination of two or more thereof.

Other examples of the polymerizable compounds having a caprolactone structure include KAYARAD HX-220, and HX-620 (trade names) (manufactured by Nippon Kayaku Co., Ltd.). The specific structures of KAYARAD HX-220 and HX-620 are shown below.

Alternatively, the polymerizable compounds having a caprolactone structure can be produced by a known method. Examples of the known method include the method as described in JP-A No. 6-16731, JP-A No. 8-143813 and JP-B No. 9-507255.

Specific examples of the (C) specific polymerizable compound of the invention is shown, but the invention is not limited thereto.

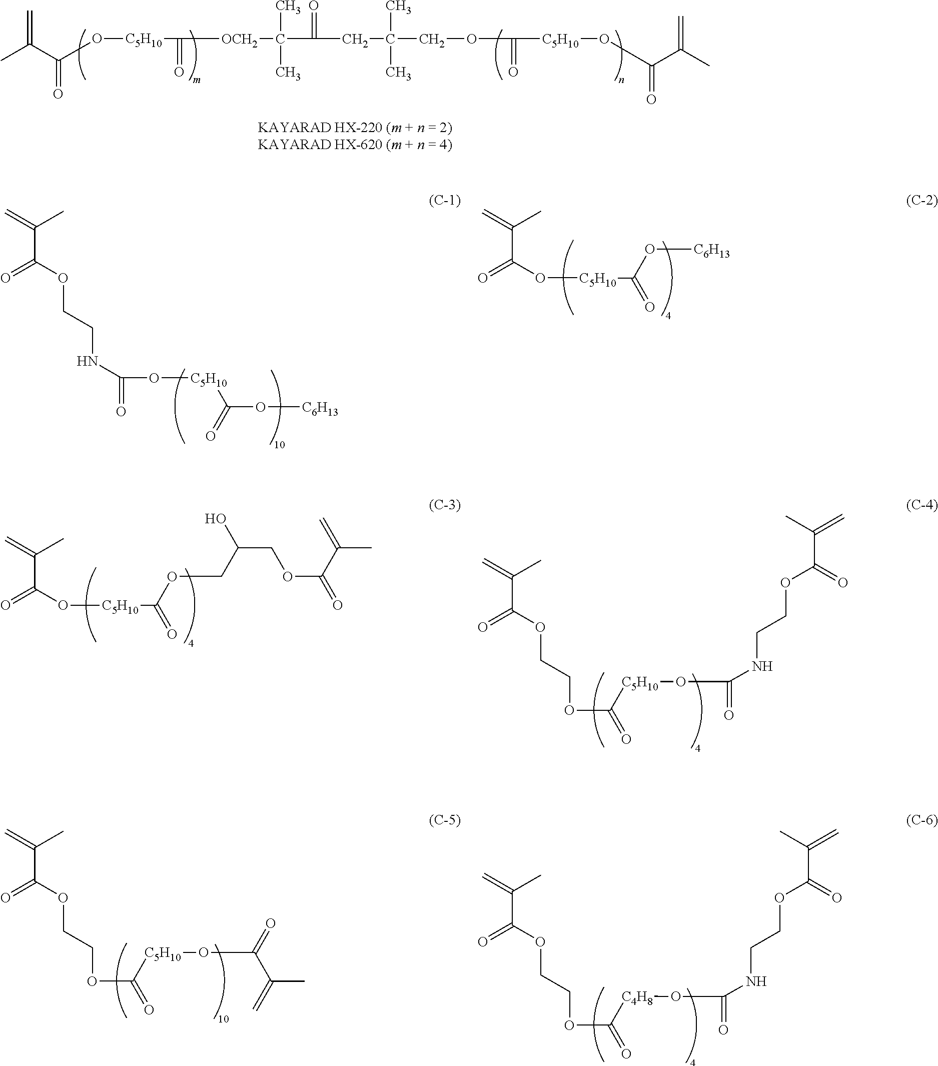

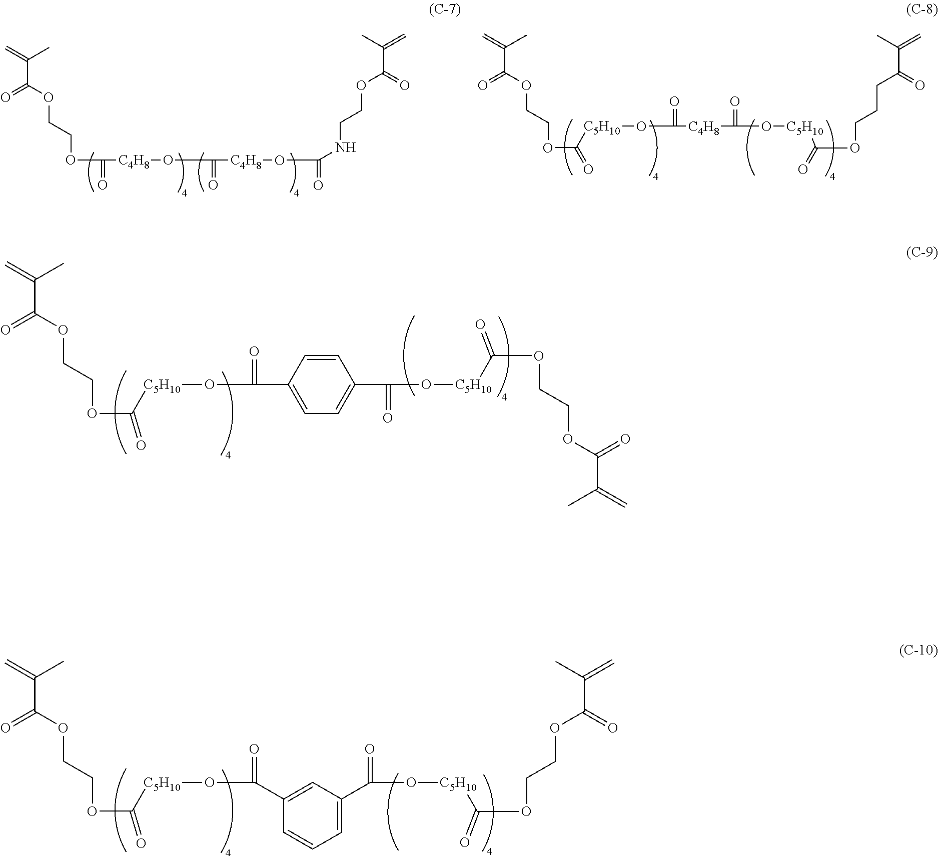

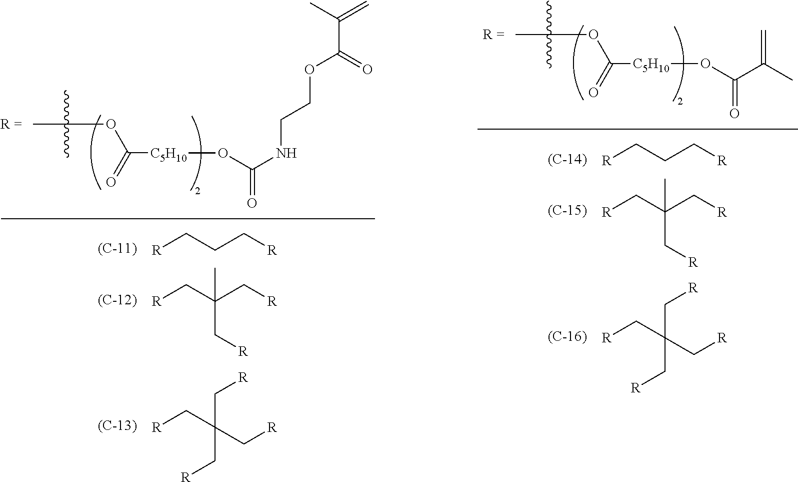

The content of the (C) specific polymerizable compound contained in the light-shielding curable composition of the invention is preferably in a range of from 3% by mass to 55% by mass with respect to the total solid content, from the viewpoints that the (A) inorganic pigment is dispersed homogeneously and stably in the composition and a good developing property is obtained. The content of the (C) specific polymerizable compound is more preferably 10% by mass to 50% by mass.

Other Polymerizable Composition

In the invention, the light-shielding curable composition may further include at least one additional polymerizable compound other than the polymerizable compound having a polyester structure, in order to improve pattern formability.

Specifically, the additional polymerizable compound may be selected from compounds having at least one terminal ethylenic unsaturated binding, and preferably at least two terminal ethylenic unsaturated bindings. These compounds are well known in the technical field, and any of them may be used in the invention without particular limitation. The chemical form thereof is not particularly limited, and the compounds may be monomers, prepolymers, that is, dimers or trimers, or oligomers, or mixtures thereof, or multimers thereof. The polymerizable compounds may be used singly, or in combination of two or more thereof.

More specifically, examples of the monomers and prepolymers include unsaturated carboxylic acids (such as acrylic acid, methacrylic acid, itaconic acid, crotonic acid, isocrotonic acid, or maleic acid) and esters, amides, and multimers thereof, and esters of unsaturated carboxylic acids and aliphatic polyhydric alcohols, amides of unsaturated carboxylic acids and aliphatic polyhydric alcohols, and multimers thereof are more preferably exemplified. Furthermore, an addition reaction product of an unsaturated carboxylic acid ester or amide having a nucleophilic substituent such as a hydroxyl group, an amino group, or a mercapto group, with a monofunctional or polyfunctional isocyanate or epoxy; a dehydration-condensation product of an unsaturated carboxylic acid ester or amide having a nucleophilic substituent such as a hydroxyl group, an amino group, or a mercapto group, with a monofunctional or polyfunctional carboxylic acid; an addition reaction product of an unsaturated carboxylic acid ester or amide having an electrophilic substituent such as an isocyanate group or an epoxy group, with a monofunctional or polyfunctional alcohol, amine, or thiol; and a substitution reaction product of an unsaturated carboxylic acid ester or amide having an elimination substituent such as a halogen group or a tosyloxy group, with a monofunctional or polyfunctional alcohol, amine, or thiol; or the like may be preferably used. Other examples include compounds obtained by replacing the unsaturated carboxylic acid with an unsaturated phosphoric acid, a vinylbenzene derivative such as styrene, vinyl ether, allyl ether, or the like.

Specific examples which can be preferably used in the invention include compounds disclosed in paragraphs [0095] to [0108] of JP-A No. 2009-288705.

As the polymerizable compound, a polymerizable monomer having at least one addition-polymerizable ethylene group, that is, a compound having at least one ethylenic unsaturated group and having a boiling point of 100° C. or more under the normal pressure, may be preferably used. Examples thereof include: monofunctional acrylates and methacrylates, such as polyethylene glycol mono(meth)acrylate, polypropylene glycol mono(meth)acrylate, or phenoxyethyl(meth)acrylate; compounds obtained by (meth)acrylation of polyfunctional alcohols to which ethylene oxide, propylene oxide, or the like has been added, such as polyethylene glycol di(meth)acrylate, tirmethylolethane tri(meth)acrylate, neopenthyl glycol di(meth)acrylate, pentaerythritol tri(meth)acrylate, pentaerythritol tetra(meth)acrylate, diepntaerythritol penta(meth)acrylate, dipentaerythritol hexa(meth)acrylate, hexanediol(meth)acrylate, trimethylol propane tri(acryloyloxypropyl)ether, tri(acryloyloxyethyl)isocyanurate, glycerin, or trimethylol ethane; urethane(meth)acrylates as disclosed in JP-B No. 48-41708, JP-B No. 50-6034, and JP-A No. 51-37193; polyester acrylates as disclosed in JP-A No. 48-64183, JP-B No. 49-43191, and JP-B No. 52-30490; and polyfunctional acrylates and methacrylates such as epoxy acrylates that are reaction products between epoxy resins and (meth)acrylic acids; and mixtures thereof.

Other examples include polyfunctional (meth)acrylates obtained by reacting a polyfunctional carboxylic acid with a compound having an ethylenic unsaturated group and a cyclic ether group such as glycidyl(meth)acrylate.

Furthermore, preferable examples of the polymerizable compounds include compounds having a fluorene ring and having 2 to more ethylenic polymerizable groups, and cardo resins, as disclosed in JP-A No. 2010-160418, JP-A No. 2010-129825, and Japan Patent No. 4364216.

Examples of the compound having at least one ethylenic unsaturated group, which is addition-polymerizable, and having a boiling point of 100° C. or more include compounds as disclosed in paragraphs [0254] to [0257] of JP-A No. 2008-292970.

Furthermore, radical polymerizable monomers represented by the following Formulae (MO-1) to (MO-5) may also be used. In the formulae, when T represents an oxyalkylene group, R is bound to the terminal of the carbon atom side of the oxyalkylene group.

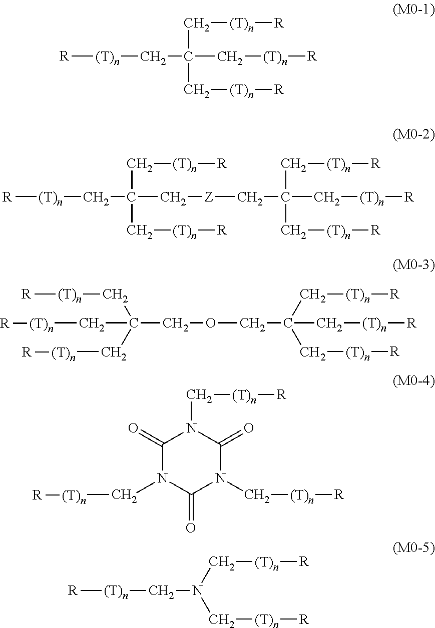

In Formulae (MO-1) to (MO-5), R, T, and Z are respectively selected from the groups shown below.

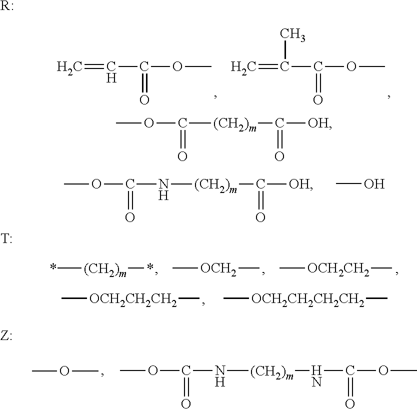

In Formula (MO-1) to (MO-5), n represents 0 to 14; m represents 1 to 8; and when plural R's and T's are present in a molecule, the plural R's and T's may be the same as or different from each other, respectively.

In each of the radical polymerizable monomers represented by Formulae (MO-1) to (MO-5), at least one of plural R's represents a group represented by —OC(═O)CH═CH₂ or —OC(═O)C(CH₃)═CH₂.

Specific examples of the radical polymerizable monomers represented by Formulae (MO-1) to (MO-5) include compounds as disclosed in paragraphs [0248] to [0251] of JP-A No. 2007-269779, which are preferably used in the invention.

As the polymerizable compound, a compound which are disclosed as a compound of Formula (1) or (2), together with specific examples thereof, in JP-A No. 10-62986 and which is obtained by (meth)acrylation of the polyfunctional alcohol to which ethylene oxide, propylene oxide, or the like has been added, may be used.

In particular, the polymerizable compound is preferably dipentaerythritol triacrylate (examples of commercially-available products thereof including KAYARAD D-330, trade name, manufactured by Nippon Kayaku Co., Ltd.), dipentaerythritol tetraacrylate (examples of commercially-available products thereof including KAYARAD D-320, trade name, manufactured by Nippon Kayaku Co., Ltd.), dipentaerythritol penta(meth)acrylate (examples of commercially-available products thereof including KAYARAD D-310, trade name, manufactured by Nippon Kayaku Co., Ltd.), dipentaerythritol hexa(meth)acrylate (examples of commercially-available products thereof including KAYARAD DPHA, trade name, manufactured by Nippon Kayaku Co., Ltd.), or a modified product thereof in which the (meth)acryloyl group has an ethylene glycol or propylene glycol reside therethrough. The oligomer types thereof can also be used.

The additional polymerizable compound may be an addition polymerizable compound having at least one ethylenically unsaturated double bond, and, specifically, an addition polymerizable compound having at least one ethylenically unsaturated bond at an end thereof and having a boiling point of 100° C. or more at normal pressure. Such compounds are well known in the technical fields, and any of them may be used in the invention without specific limitation.

The content of polymerizable compounds (i.e., the total content of the (C) specific polymerizable compound and the additional polymerizable compound) in the light-shielding curable composition of the invention is preferably from 3% by mass to 55% by mass, and more preferably from 10% by mass to 50% by mass, with respect to the total solid content of the light-shielding curable composition. The content of the (C) specific polymerizable compound in the light-shielding curable composition of the invention is preferably in a range of from 20% by mass to 100% by mass, and particularly preferably in a range of from 50% by mass to 100% by mass, with respect to the total mass of the polymerizable compounds to be used (including the (C) specific polymerizable compound and additional polymerizable compound).

(D) Polymerization Initiator

The (D) polymerization initiator used in the invention is preferably a compound which is decomposed by light or heat to initiate and promote polymerization of the (C) specific polymerizable compound. In particular, a preferable polymerization initiator is a compound (hereinafter, also referred to as “photopolymerization initiator”) which absorbs light in the wavelength region of 300 nm to 500 nm to generate a radical.

Specific examples of the polymerization initiator include organic halogenated compounds, oxydiazole compounds, carbonyl compounds, ketal compounds, benzoin compounds, organic peroxide compounds, azo compounds, coumarin compounds, azide compounds, metallocene compounds, organic boric acid compounds, disulfonic acid compounds, oxime ester compounds, onium salt compounds and acyl phosphine (oxide) compounds. In particular, oxime ester compounds are preferred from the viewpoint of adhesiveness.

More specifically, examples of the polymerization initiator include polymerization initiators described in paragraphs [0081] to [0100], [0101] to [0139] of JP-A No. 2006-78749.

The content of the (D) polymerization initiator in the light-shielding curable composition of the invention is preferably in a range of from 0.1% by mass to 30% by mass with respect to the total solid content of the light-shielding curable composition, from the viewpoints of achieving a good curing property and a good developing property. Further, the content of the (D) polymerization initiator is more preferably in a range of from 1% by mass to 25% by mass, and still more preferably in a range of from 2% by mass to 20% by mass, with respect to the total solid content of the light-shielding curable composition.

(E) Solvent

In general, when the colored curable composition of the invention is prepared, the composition may generally contain a solvent. The solvent to be used is not basically limited, as long as solubility of respective components of the light-shielding curable composition and coating property of the light-shielding curable composition are satisfied. In particular, it is preferred that the solvent is selected in consideration of solubility of the binder, coating property, and safety.

Examples of the solvents include acetone, methyl ethyl ketone, cyclohexane, ethyl acetate, butyl acetate, methyl 3-ethoxypropionate, ethyl 3-ethoxypropionate, methyl 3-methoxypropionate, ethyl cellosolve acetate, ethylene dichloride, tetrahydrofuran, toluene, ethylene glycol monomethyl ether, ethylene glycol monoethyl ether, ethylene glycol dimethyl ether, propylene glycol monomethyl ether, propylene glycol monoethyl ether, acetylacetone, 2-heptanone, cyclohexanone, diacetone alcohol, ethylene glycol monomethyl ether acetate, ethylene glycol ethyl ether acetate, ethylene glycol monoisopropyl ether, ethylene glycol monobutyl ether acetate, 3-methoxypropanol, methoxy methoxy ethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylformamide, dimethyl sulfoxide, γ-butyrolactone, methyl lactate, ethyl lactate, ethyl carbitol acetate, and butyl carbitol acetate.

Among them, examples of more preferable solvents include methyl 3-ethoxypropionate, ethyl 3-ethoxypropionate, ethyl cellosolve acetate, ethyl lactate, diethylene glycol dimethyl ether, butyl acetate, methyl 3-methoxypropionate, 2-hepatanone, cyclohexanone, ethyl carbitol acetate, butyl carbitol acetate, propylene glycol methyl ether, and propylene glycol methyl ether acetate.

The solvents can be used alone or in a mixture of two or more of them.

It is preferred that the light-shielding curable composition of the inventino contains the (E) solvent in such an amount that a concentration of the total solid content in the light-shielding curable composition is in a range of from 2% by mass to 60% by mass.

(F) Other Additives

The light-shielding curable composition of the invention may include any of various additives in addition to the components (A) to (E), depending on the purpose.

### (F-1) Binder Polymer

The light-shielding curable composition of the invention may optionally include a binder polymer for the improvement of film properties. An example of the binder polymer usable in the invention is a linear organic polymer. As the linear organic polymer, any one of known polymers can be arbitrarily used. In order to perform development with water or weakly alkaline water, it is preferable to select a linear organic polymer which is soluble or swellable in water or weakly alkaline water. The linear organic polymer is selected and used depending on use not only as a film forming agent but also as a developing agent for water, weakly alkaline water or organic solvent development.

For example, a water-soluble organic polymer enables development with water. Examples of the linear organic polymer include a radical polymer having a carboxylic acid group at a side chain thereof, for example, those described in JP-A No. 59-44615, JP-B No. 54-34327, JP-B No. 58-12577, JP-B No. 54-25957, JP-A No. 54-92723, JP-A No. 59-53836 and JP-A No. 59-71048, and more specifically, a resin formed by homopolymerization or copolymerization of monomers having a carboxylic group; a resin formed by homopolymerization or copolymerization of monomers having an acid anhydride and allowing the acid anhydride unit to undergo hydrolysis, half-esterification or half-amidation; and epoxy acrylates obtained by modifying an epoxy resin with an unsaturated monocarboxylic acid and an acid anhydride. Examples of monomers having a carboxylic group include acrylic acid, methacrylic acid, itaconic acid, crotonic acid, maleic acid, fumaric acid, and 4-carboxyl styrene. Examples of monomers having an acid anhydride include maleic anhydride.

Similarly, an acidic cellulose derivative having a carboxylic group in a side chain thereof may be used. Furthermore, a binder polymer obtained by adding a cyclic acid anhydride to a polymer having a hydroxyl group is useful.

It is preferable to use a urethane binder polymer containing an acidic group (for example, those described in JP-B No. 7-12004, JP-B No. 7-120041, JP-B No. 7-120042, and JP-B No. 8-12424 and JP-A No. 63-287944, JP-A No. 63-287947, JP-A No. 1-271741 and JP-A No. 11-352691) from the viewpoints of low exposure suitability, because the urethane binder polymer has extremely high strength.

In addition, an acetal-modified polyvinyl alcohol binder polymer having an acidic group (for example, those described in EP Patent No. 993966 and EP Patent No. 1204000, and JP-A No. 2001-318463) is preferable in that the balance between film strength and the developing property is excellent. Furthermore, polyvinyl pyrrolidone or polyethylene oxide may preferably be used as the water soluble linear organic polymer. In order to increase the strength of a cured film, for example, alcohol soluble nylon or a polyether of 2,2-bis-(4-hydroxyphenyl)-propane and epichlorohydrine may be preferably used.

In particular, among them, a copolymer of [benzyl(meth)acrylate/(meth)acrylic acid/optional another addition polymerizable vinyl monomer], or a copolymer or [allyl(meth)acrylate/(meth)acrylic acid/optional another addition polymerizable vinyl monomer] is preferable in that the balance of film strength, sensitivity and developing property is excellent.

The binder polymer can be synthesized by a known method in the technical field. Examples of solvent used in the synthesis include tetrahydrofuran, ethylene dichloride, and cyclohexanone. These solvents may be used alone or in a mixture of two or more kinds thereof.

Examples of radical polymerization initiator to be used when the binder polymer is synthesized include known compounds such as an azo initiator and a peroxide initiator.

Among the binder polymers, when an alkali-soluble resin having a double bond in a side chain thereof is used, both the curing property of an exposed portion and the alkali developing property of an unexposed portion can be improved.

The alkali-soluble binder polymer having a double bond in a side chain thereof, which can be used in the invention, has an acid group that imparts alkali solubility to the resin and at least one unsaturated double bond, in order to improve various performances such as the removability of the non-image section. The binder resin having such a structure is described in detail, for example, in JP-A No. 2003-262958, and the compounds described therein can be used in the invention.

The mass average molecular weight of the binder polymer to be used in the light-shielding curable composition of the invention is preferably 30,000 to 300,000, more preferably 35,000 to 250,000, even more preferably 40,000 to 200,000 and particularly preferably 45,000 to 100,000, from the viewpoints of pattern peeling inhibition and the developing property during development.

The mass average molecular weight of the binder polymer can be measured by, for example, Gel Permeation Chromatography (GPC).

The content of the binder polymer with respect to the total solid content of the light-shielding curable composition of the invention is preferably from 0.1% by mass to 7.0% by mass. From the viewpoints of both the inhibition of pattern peeling and the suppression of development residues, the content of the binder polymer is more preferably from 0.3% by mass to 6.0% by mass and even more preferably 1.0% by mass to 5.0% by mass.

(F-2) Other Light-Shielding Materials

In the light-shielding curable composition of the invention, a light-shielding material other than the inorganic pigment, which is selected from known organic pigments and dyes, may be used in combination with the inorganic pigment, in order to impart desirable light-shielding properties to the curable composition.

Examples of the additional light-shielding material which can be combined include organic pigments such as the pigments as described in paragraphs [0030] to [0044] of JP-A No. 2008-224982 and pigments obtained by substituting a chloro group of C.I. Pigment Green 58 or C.I. Pigment Blue 79 with a hydroxyl group. In particular, examples of such pigments preferably used in the invention include, but not limited thereto, the following pigments:

C.I. Pigment Yellow 11, 24, 108, 109, 110, 138, 139, 150, 151, 154, 167, 180, 185;

C.I. Pigment Orange 36;

C.I. Pigment Red 122, 150, 171, 175, 177, 209, 224, 242, 254, 255;

C.I. Pigment Violet 19, 23, 29, 32;

C.I. Pigment Blue 15:1, 15:3, 15:6, 16, 22, 60, 66;

C.I. Pigment Green 7, 36, 37, 58; and

C.I. Pigment Black 1, 7.

The dye which can be used as the additional light-shielding material is not particularly limited, and any dye selected from known dyes may be used. Example of dyes includes dyes disclosed in JP-A No. 64-90403, JP-A No. 64-91102, JP-A No. 1-94301, JP-A No. 6-11614, Japanese Patent No. 2592207, U.S. Pat. No. 4,808,501, U.S. Pat. No. 5,667,920, U.S. Pat. No. 5,059,500, JP-A No. 5-333207, JP-A No. 6-35183, JP-A No. 6-51115, JP-A No. 6-194828, JP-A No. 8-211599, JP-A No. 4-249549, JP-A No. 10-123316, JP-A No. 11-302283, JP-A No. 7-286107, JP-A No. 2001-4823, JP-A No. 8-15522, JP-A No. 8-29771, JP-A No. 8-146215, JP-A No. 11-343437, JP-A No. 8-62416, JP-A No. 2002-14220, JP-A No. 2002-14221, JP-A No. 2002-14222, JP-A No. 2002-14223, JP-A No. 8-302224, JP-A No. 8-73758, JP-A No. 8-179120, and JP-A No. 8-151531.

Examples of usable dyes include pyrazole azo dyes, anilino azo dyes, triphenylmethane dyes, anthraquinone dyes, anthrapyridone dyes, benzylidene dyes, oxonol dyes, pyrazolotriazole azo dyes, pyridone azo dyes, cyanine dyes, phenothiazine dyes, pyrrolopyrazole azomethine dyes, xanthene dyes, phthalocyanine dyes, benzopyran dyes, and indigo dyes.

In the invention, regarding a combination of the inorganic pigment with the additional light-shielding material for satisfying both curing property and light-shielding properties, it is preferable to use a combination of titanium black pigment with at least one of an orange pigment, a red pigment and a violet pigment from the viewpoints of obtaining a light-shielding curable composition having neutral black color, in which light of the wavelength region of from 400 nm to 700 nm is absorbed homogeneously. The most preferable example is a combination of a titanium black pigment and a red pigment.

(F-3) Sensitizer

When a photopolymerization initiator is used as the (D) polymerizable compound of the light-shielding curable composition of the invention, the light-shielding curable composition may further contain a sensitizer for the purposes of improving radical generation efficiency of the polymerization initiator and shifting sensitization wavelengths to the longer wavelength side.

Any sensitizer may be preferably used in the invention as long as it can sensitize the polymerization initiator used in combination therewith, through an electron transfer mechanism or an energy transfer mechanism.

Preferable examples of the sensitizer include compounds described in paragraphs to [0098] of JP-A No. 2008-214395.

The content of the sensitizer is preferably in a range of from 0.1% by mass to 30% by mass, more preferably in a range of from 1% by mass to 20% by mass, and even more preferably in a range of from 2% by mass to 15% by mass, with respect to the total solid content of the light-shielding curable composition from the viewpoints of sensitivity and storage stability.

(F-4) Polymerization Inhibitor

It is preferable that the light-shielding curable composition of the invention contains a polymerization inhibitor in order to suppress polymerization reactions of polymerizable compounds during production or storage of the composition. The polymerization inhibitor may be a known thermal polymerization inhibitor, and specific examples thereof include hydroquinone, p-methoxyphenyl, di-t-butyl-p-cresol, pyrogallol, t-butylcatechol, benzoquinone, 4,4′-thiobis-(3-methyl-6-t-butylphenol), 2,2′-methylenebis-(4-methyl-6-t-butylphenol), and N-nitrosophenylhydroxylamine cerium (I) salt.

The amount of thermal polymerization inhibitor to be added is preferably from about 0.01% by mass to about 5% by mass with respect to the total solid content of the light-shielding curable composition of the invention.

The composition may optionally contain, for example, a higher fatty acid derivative such as behenic acid or behenic acid amide for preventing polymerization inhibition by oxygen. When the light-shielding curable composition containing a higher fatty acid derivative is coated and dried to form a film, the higher fatty acid derivative is localized at the surface of the coated film, and thereby permeation of oxygen into the film is suppressed and polymerization inhibition caused by oxygen is effectively suppressed in the exposed region of the coated film. The amount of the higher fatty acid derivative to be added is preferably from about 0.5% by mass to about 10% by mass with respect to the total mass of the light-shielding curable composition of the invention.

(F-5) Adhesion Improving Agent

An adhesion improving agent may be added to the light-shielding curable composition of the invention in order to improve adhesiveness to the surface of a hard material such as a support. Examples of the adhesion improving agent include a silane coupling agent and a titanium coupling agent.

Preferable examples of the silane coupling agent include γ-methacryloxypropyl trimethoxy silane, γ-methacryloxypropyl triethoxy silane, γ-acryloxypropyl trimethoxy silane, γ-acryloxypropyl triethoxy silane, γ-mercaptopropyl trimethoxy silane, γ-aminopropyl triethoxy silane and phenyl trimethoxy silane. More preferable examples include γ-methacryloxypropyl trimethoxy silane.

The amount of the adhesion improving agent to be added is preferably from 0.5% by mass to 30% by mass, and more preferably from 0.7% by mass to 20% by mass, with respect to the total solid content of the light-shielding curable composition of the invention. In particular, when the resist (i.e., the curable composition) of the present invention is used for forming a lens on a glass substrate, it is preferable to add an adhesion improving agent to the resist from the viewpoint of the improvement of sensitivity.

The light-shielding curable composition of the invention may be produced by mixing the (A) inorganic pigment, the (B) dispersant having a polyester structure, the (C) polymerizable compound having a polyester structure, the (D) polymerization initiator, and the (E) solvent and, optionally, various additives.

The reason that the light-shielding curable composition of the invention is excellent in terms of a light-shielding property, a developing property and pattern edge formability is thought to be as follows. In other words, since the (B) dispersant has a polyester structure, and exhibits excellent property of homogeneously dispersing the (A) inorganic pigment, a homogeneous dispersion is obtained even when a blending ratio of the inorganic pigment is high. Further, the (C) polymerizable compound also has a polyester structure, and therefore compatibility of the (C) polymerizable compound and the (B) dispersant is good when they are dissolved together in the (E) solvent, and a light-shielding curable composition in which the (A) inorganic pigment is homogeneously dispersed is obtained. Further, since the (B) dispersant has a polyester structure and the (C) polymerizable compound also has a polyester structure, a light-shielding curable composition having excellent solubility with respect to a developer is obtained. As a result, when the light-shielding curable composition of the invention is cured, followed by development using a developer, the discrimination between a cured section and an uncured section with respect to a developer is excellent, and an uncured light-shielding curable composition is cleanly removed by the developer without generation of development residues. As a result, a light-shielding region which is formed using the light-shielding curable composition of the invention has a sharp pattern edge.

Since the light-shielding curable composition of the invention has such a configuration, a light-shielding film which is cured at high sensitivity and has an excellent light-shielding property can be formed. Further, when an alkali-soluble polymer as the (F-1) binder polymer is used in combination with the above components, aqueous alkali solution can be used as a developer for removing an uncured portion of the light-shielding curable composition, and a highly precise light-shielding pattern is formed, and therefore the light-shielding curable composition is useful for forming a light-shielding film for a wafer level lens or a black matrix for a liquid crystal display.

Wafer Level Lens

The wafer level lens of the invention has a light-shielding film obtained by curing the light-shielding curable composition of the invention on a peripheral portion of a lens.

The wafer level lens of the invention will be described below.

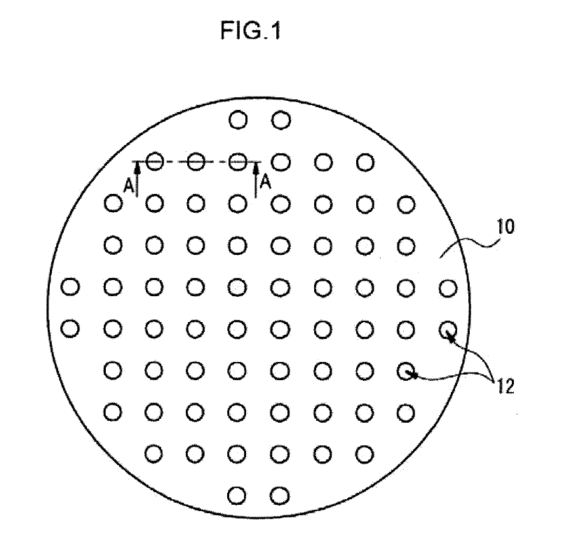

FIG. 1 is a plan view showing one example of a configuration of a wafer level lens array having plural wafer level lenses.

As shown in FIG. 1, the wafer level lens array has a substrate 10 and lenses 12 arranged in the substrate 10. In FIG. 1, the plural lenses 12 are arranged two-dimensionally with respect to the substrate 10, but may be arranged one-dimensionally.

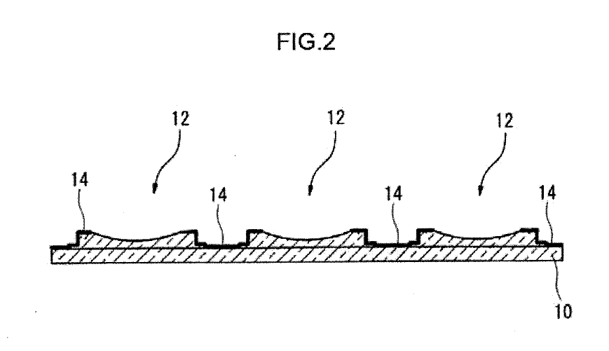

FIG. 2 is a cross-sectional view of the wafer level lens array shown in FIG. 1, which is taken along the line A-A.

As shown in FIG. 2, the wafer level lens array has the substrate 10 and plural lenses 12 arranged on the substrate 10. The plural lenses 12 may be arranged one-dimensionally or two-dimensionally with respect to the substrate 10.

A wafer level lens of the invention includes a lens 12 present on the substrate 10 and a light-shielding film 14 provided in the peripheral portion of the lens. The light-shielding curable composition of the invention is used in forming the light-shielding film 14.

In the following, an embodiment of the invention, in which plural lenses 12 are arranged two-dimensionally with respect to the substrate 10 as shown FIG. 1, is described. The lens 12 is generally formed from the same material as that of the substrate 10 and may be integrally formed on the substrate 10, or may be formed as a separate structure and fixed on the substrate.

In the above, an example of the wafer level lens of the invention is described, but the invention is not limited to this embodiment, and various embodiments such as one which has a multilayer structure or one which is separated into lens modules by dicing, may be employed.

Examples of materials for forming the lens 12 include glass. There are various types of glass, and thus a glass having a high refractive index can be selected from these; therefore, glass is preferably used as a material for a lens having high power. Further, glass has advantages of excellent heat resistance and withstanding reflow-mounting on an imaging unit.

Examples of other materials for forming the lens 12 include resins. A resin has excellent workability, and thus it is suitable in that the surface of the lens is formed easily and cheaply using, for example, a mold.

The wafer level lens is preferably formed using a resin having energy-curing property. The resin having energy-curing property may be any of a resin which is cured by heating or a resin which is cured by irradiation of active energy rays (for example, application of heat, ultraviolet rays or electron rays).

Considering reflow-mounting of the imaging unit, a resin having a relatively high softening point, for example, 200° C. or more is preferred, and a resin having a softening point of 250° C. or more is more preferred.

The preferable resin as the lens material will be described below.

Examples of an ultraviolet curable resin include an ultraviolet curable silicon resin, an ultraviolet curable epoxy resin, and an acryl resin. The epoxy resin which can be used has a linear expansion coefficient of from 40 to 80 [10⁻⁶/K] and has a refractive index of from 1.50 to 1.70, and preferably from 1.50 to 1.65.

Examples of a thermosetting resin include a thermosetting silicon resin, a thermosetting epoxy resin, a thermosetting phenol resin, and a thermosetting acryl resin. For example, the silicon resin which can be used has a linear expansion coefficient of from 30 to 160 [10⁻⁶/K] and has a refractive index of from 1.40 to 1.55. For example, the epoxy resin which can be used has a linear expansion coefficient of from 40 to 80[10⁻⁶/K] and has a refractive index of from 1.50 to 1.70, and preferably from 1.50 to 1.65.

The phenol resin which can be used has a linear expansion coefficient of from 30 to 70 [10⁻⁶/K] and has a refractive index of from 1.50 to 1.70. The acryl resin which can be used has a linear expansion coefficient of from 20 to 60 [10⁻⁶/K] and has a refractive index of from 1.40 to 1.60, and preferably from 1.50 to 1.60.

Other examples of the thermosetting resin include an epoxy resin and a siloxane resin. A commercial product can be used as the thermosetting resin. Specific examples thereof include SMX-7852 and SMX-7877 (trade names, manufactured by FUJI POLYMER INDUSTRIES CO., LTD.), IVSM-4500 (trade name, manufactured by TOSHIBA CORPORATION), and SR-7010 (trade name, manufactured by Dow Corning Toray Co., Ltd.).

Examples of a thermoplastic resin include a polycarbonate resin, a polysulfone resin, and a polyester sulfone resin. The polycarbonate resin which can be used has a linear expansion coefficient of from 60 to 70 [10⁻⁶/K] and has a refractive index of from 1.40 to 1.70, and preferably from 1.50 to 1.65. The polysulfone resin which can be used has a linear expansion coefficient of from 15 to 60 [10⁻⁶/K] and has a refractive index of 1.63. The polyether sulfone resin which can be used has a linear expansion coefficient of from 20 to 60 [10⁻⁶/K] and has a refractive index of 1.65.

Optical glass generally has a linear expansion coefficient of from 4.9 to 14.3 [10⁻⁶/K] at 20° C. and has a refractive index of from 1.4 to 2.1 at wavelength of 589.3 nm. Quartz glass has a linear expansion coefficient of from 0.1 to 0.5 [10⁻⁶/K] and has a refractive index of about 1.45.

It is preferred that the curable resin composition which can be applied to formation of the lens has a suitable flowability before curing, from the viewpoints of transfer suitability and formability of mold shape. Specifically, it is preferred that the curable resin composition is liquid at room temperature and has a viscosity of from about 1,000 mPa·s to about 50,000 mPa·s.

It is preferred that the curable resin composition which can be applied to formation of the lens has a heat resistance that does not suffer from heat deformation through a reflow process after curing. From these viewpoints, a glass transition temperature of the cured material is preferably 200° C. or more, more preferably 250° C. or more and particularly preferably 300° C. or more. In order to impart such a high heat resistance to the resin composition, it is necessary to suppress mobility at a molecular level. Examples of an effective method therefor include: (1) increasing a crosslinking density per unit volume; (2) using a resin having a rigid cyclic structure (for example, a resin having an alicyclic structure such as cyclohexane, norbornane, or tetracyclododecane, an aromatic structure such as benzene or naphthalene, a cardo structure such as 9,9′-biphenyl fluorene, and a spiro structure such as spirobiindane; specifically, for example, resins described in JP-A No. 9-137043, JP-A No. 10-67970, JP-A No. 2003-55316, JP-A No. 2007-334018, JP-A No. 2007-238883); and (3) homogeneously dispersing a high Tg material such as an inorganic fine particle (for example, those described in JP-A No. 5-209027 and JP-A No. 10-298265). These methods may be used singly or in combination of plural kinds, and are preferably adjusted in a range not impairing other properties such as flowability, shrinkage ratio, and refractive index.

From the viewpoints of the degree of precision of shape transfer, a resin composition which exhibits a low volume shrinkage ratio by curing reaction is preferred. The curing shrinkage ratio of the resin composition used in the invention is preferably 10% or less, more preferably 5% or less, and particularly preferably 3% or less.

Examples of the resin composition having a low curable shrinkage ratio include the following (1) to (6):

(1) a resin composition containing a high molecular weight curing agent (for example, prepolymer) (for example, a composition in described in JP-A No. 2001-19740, JP-A No. 2004-302293, and JP-A No. 2007-211247), in which the number average molecular weight of the high molecular weight curing agent is preferably in a range of from 200 to 100,000, more preferably in a range of from 500 to 50,000 and particularly preferably in a rage of from 1,000 to 20,000; and a value obtained by calculating the number average molecular weight of the curing agent/the number of curing reactive groups in the curing agent is preferably in a range of from 50 to 10,000, more preferably in a range of from 100 to 5,000 and particularly preferably in a range of from 200 to 3,000;

(2) a resin composition containing a non-reactive material (for example, an organic fine particle, an inorganic fine particle, or a non-reactive resin) (for example, the composition described in JP-A No. 6-298883, JP-A No. 2001-247793 and JP-A No. 2006-225434);

(3) a resin composition containing a lower shrinkage-crosslinking reactive group (for example, a ring-opening polymerizable group such as an epoxy group (for example, one described in JP-A No. 2004-210932), an oxetanyl group (for example, one described in JP-A No. 8-134405), an episulfide group (for example, one described in JP-A No. 2002-105110), a cyclic carbonate group (for example, one described in JP-A No. 7-62065), an ene/thiol curing group (for example, one described in JP-A No. 2003-20334), a hydrosilylation curing group (for example, one described in JP-A No. 2005-15666);

(4) a resin composition containing a resin having a rigid skeleton (for example, fluorene, adamantane, or isophorone) (for example, one described in JP-A No. 9-137043);

(5) a resin composition which contains two kinds of monomers having different polymerizable groups and forms an interpenetrating-network structure (i.e., IPN structure) (for example, one described in JP-A No. 2006-131868); and

(6) a resin composition containing an expansible material (for example, composition in described JP-A No. 2004-2719 and JP-A No. 2008-238417). Further, it is preferable to use a combination of two or more of the curing shrinkage-reducing means (for example, a resin composition which contains a prepolymer containing a ring-opening polymerizable group and fine particles), from the viewpoint of optimization of physical properties.

For forming the wafer level lens of the invention, two kinds or more of resin compositions having different high-low Abbe numbers are preferred.

In a resin having a high Abbe number, the Abbe number (vd) is preferably 50 or more, more preferably 55 or more, and particularly preferably 60 or more. The refractive index (nd) of the resin is preferably 1.52 or more, more preferably 1.55 or more and particularly preferably 1.57 or more.

The resin is preferably an aliphatic resin, and is more preferably a resin having an alicyclic structure (for example, a resin having a cyclic structure such as cyclohexane, norbornane, adamantane, tricyclodecane, or tetracyclododecane, specifically for example, resins described in JP-A No. 10-152551, JP-A No. 2002-212500, JP-A No. 2003-20334, JP-A No. 2004-210932, JP-A No. 2006-199790, JP-A No. 2007-2144, JP-A No. 2007-284650, and JP-A No. 2008-105999).

In a resin having a low Abbe number, the Abbe number (vd) is preferably 30 or less, more preferably 25 or less, and particularly preferably 20 or less. The refractive index (nd) of the resin is preferably 1.60 or more, more preferably 1.63 or more and particularly preferably 1.65 or more.

The resin is preferably a resin having an aromatic structure, and more preferably, for example, a resin containing a structure of 9,9′-diarylfluorene, naphthalene, benzothiazole, benzotriazole, or the like (specifically, for example, resins described in JP-A No. 60-38411, JP-A No. 10-67977, JP-A No. 2002-47335, JP-A No. 2003-238884, JP-A No. 2004-83855, JP-A No. 2005-325331, JP-A No. 2007-238883, WO 2006/095610, and JP No. 2537540).

As a resin used for forming a wafer level lens, it is preferable to use an organic or inorganic composite material containing inorganic fine particles dispersed in a matrix in combination with the above resin, from the viewpoints of increasing a refractive index or adjusting the Abbe number.

Examples of the inorganic fine particles include oxide fine particles, sulfide fine particles, selenide fine particles, and telluride fine particles. Specific examples include fine particles of zirconium oxide, titanium oxide, zinc oxide, tin oxide, zinc sulfide, or the like. More specific examples include fine particles of zirconium oxide, titanium oxide, zinc oxide, tin oxide, niobium oxide, cerium oxide, aluminum oxide, lanthanum oxide, yttrium oxide, zinc sulfide or the like.

In particular, the resin having a high Abbe number preferably contains fine particles of lanthanum oxide, aluminum oxide, zirconium oxide, or the like dispersed therein. The resin having a low Abbe number preferably contains fine particles of titanium oxide, tin oxide, zirconium oxide, or the like dispersed therein.

The inorganic fine particles may be used alone or in combination of two or more kinds. Further, the inorganic fine particles may be a composite of plural components.

Further, in order, for example, to reduce photocatalytic activity and water absorption in inorganic fine particles, the inorganic fine particles may be doped with a heterogeneous metal, or a surface layer thereof may be coated with a heterogeneous metal oxide such as silica or alumina, or the surface thereof may be modified using a silane coupling agent, a titanate coupling agent, an organic acid (for example, carboxylic acid, sulfonic acid, phosphoric acid, or phosphonic acids) or a dispersant having an organic acid group.

The number average primary particle size of the inorganic fine particles may be generally from about 1 nm to 1,000 nm. When the particle size is too small, there are cases where the physical properties are changed. When the particle size is too large, the effect of Rayleigh scattering is pronounced. In this regard, the number average primary particle size is preferably from 1 nm to 15 nm, more preferably from 2 nm to 10 nm and particularly preferably from 3 nm to 7 nm. Further, a narrower particle size distribution of the inorganic fine particles is preferred. The monodispersed particle has various definitions, and for example, the defined range of values as described in JP-A No. 2006-160992 corresponds to a preferable particle size distribution range.

The number average primary particle size described above can be measured using, for example, an X-Ray Diffraction (XRD) apparatus or a transmission electron microscope (TEM).

The refractive index of the inorganic fine particles is preferably from 1.90 to 3.00 at 22° C. and at a wavelength of 589.3 nm, more preferably from 1.90 to 2.70, and particularly preferably from 2.00 to 2.70.

The content of the inorganic fine particles with respect to the resin is 5% by mass or more, more preferably from 10% by mass to 70% by mass, and particularly preferably from 30% by mass to 60% by mass, from the viewpoints of transparency and higher refractive index.

Examples of the resin serving as the matrix used in the organic inorganic composite material include the ultraviolet curable resin, thermosetting resin, or thermoplastic resin described above as wafer level lens materials. Further, examples of the resin include a resin having a refractive index higher than 1.60, such as those described in JP-A No. 2007-93893; a block copolymer consisting of a hydrophobic segment and a hydrophilic segment, such as those described in JP-A No. 2007-211164; a resin having a functional group capable of forming an arbitrary chemical bond with an inorganic fine particle, at an end or side chain of a high molecular, such as those described in JP-A No. 2007-238929, JP-A No. 2010-043191, JP-A No. 2010-065063, JP-A No. 2010-043817; and a thermoplastic resin described in JP-A No. 2010-031186 and JP-A No. 2010-037368. Additives such as a plasticizer or a dispersant can be optionally added to the organic inorganic composite material.

In order to homogeneously disperse fine particles in the resin composition, the fine particles are preferably dispersed by suitably using for example, a dispersant containing a functional group having a reactivity to the resin monomer for forming a matrix (for example, dispersant described in Examples of JP-A No. 2007-238884), a block copolymer consisting of a hydrophobic segment and a hydrophilic segment (for example, one described in JP-A No. 2007-211164) or a resin having a functional group which can form optional chemical bonds with inorganic fine particles in an end or a side chain of a high molecular (for example, one described in JP-A No. 2007-238929 and JP-A No. 2007-238930).

Further, the resin composition for forming a wafer level lens used in the invention may suitably blended with an additive such as a known releasing agent such as a silicon compound, fluorine-containing compound, or long-chain alkyl group-containing compound; or an antioxidant such as hindered phenol.

The resin composition used in producing the wafer level lens of the invention can be optionally blended with a curing catalyst or initiator. Specific examples thereof include a compound that promotes the curing reaction (radical polymerization or ion polymerization) by action of heat or active energy rays described in paragraphs [0065] to [0066] of JP-A No. 2005-92099. The amount of the curing reaction promoter to be added may vary depending on the kind of catalyst or initiator, or curing reactive portion, and thus the amount cannot be unconditionally set, but generally the amount is preferably from about 0.1% by mass to 15% by mass, and more preferably from about 0.5% by mass to 5% by mass, with respect to the total solid content of the curing reactive resin composition.

The resin composition used in producing the wafer level lens of the invention can be produced by suitably blending the components. At this time, when components other than a liquid lower molecular weight monomer (reactive diluent) can be dissolved therein, no separate solvent is required to be added, while in a case in which the components cannot be dissolved in the liquid lower molecular weight monomer, respective components may be dissolved using a solvent, thereby preparing a resin composition. The solvent which can be used in the resin composition is not specifically limited, and can be selected suitably as long as no precipitation is generated in the resultant composition, and homogeneous dissolution and dispersion are achieved. Specific examples of the solvent include ketones (for example, acetone, methyl ethyl ketone, and methyl isobutyl ketone), esters (for example, ethyl acetate and butyl acetate), ethers (for example, tetrahydrofuran and 1,4-dioxane), alcohols (for example, methanol, ethanol, isopropyl alcohol, butanol, and ethylene glycol), aromatic hydrocarbons (for example, toluene and xylene), and water. When the resin composition contains the solvent, it is preferred that the composition is cast on a substrate and/or a mold, and the solvent is dried, followed by carrying out the transfer operation by mold shape.

Formation of Wafer Level Lens

The substrate 10 may be formed from the same material as the molding material of the lens 12. The substrate 10 may be formed from a material different from the molding material of the lens 12 as long as the substrate 10 is formed from a material transparent with respect to visible light, such as a glass. In this case, it is preferred that the material for forming the substrate 10 has the same or substantially the same linear expansion coefficient as that of the material for forming the lens 12. In a case in which a linear expansion coefficient of the material for forming lens 12 is the same or substantially the same as that of the material for forming the substrate 10, distortion or breaking of the lens 12 during heating, which is caused owing to different linear expansion ratios, can be suppressed in reflow mounting of the wafer level lens on an imaging unit.

Further, an infrared filter (IR filter) may be formed on the surface of the optical incidence side of the substrate 10 (not shown in FIGS. 1 and 2).

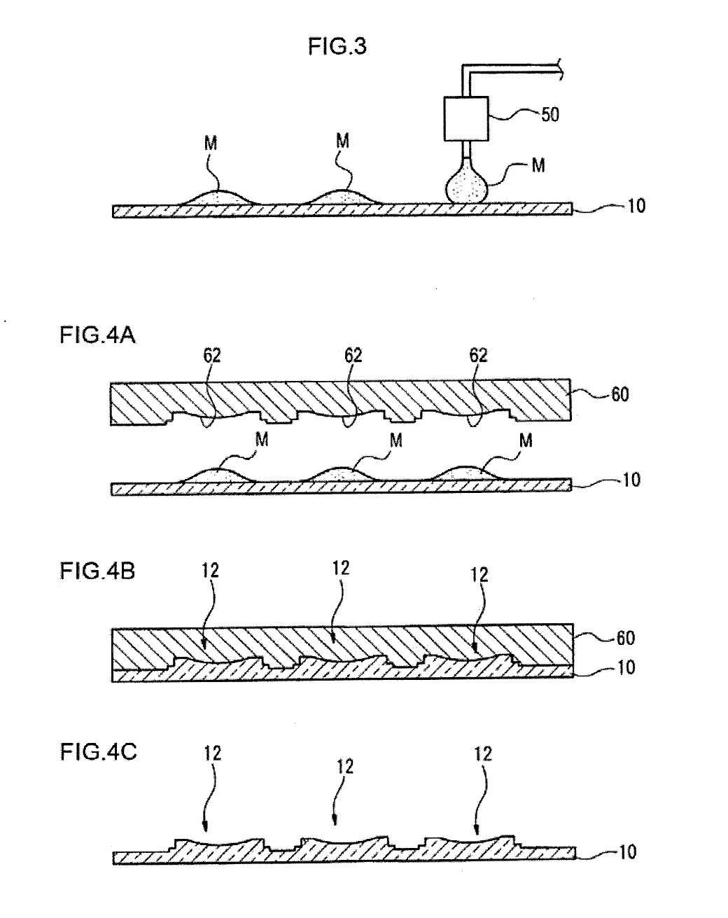

Hereinafter, with reference to FIGS. 3 to 8C, specific description will be given to the configuration and production of a wafer level lens, by referring to a method of producing a wafer level lens array.

### Configuration and Production of Wafer Level Lens (1)

FIG. 3 is a schematic view showing the state of supplying a resin as a molding material (referred to as “M” in FIG. 3) onto a substrate. As shown in FIG. 3, the molding material M is applied dropwise using a dispenser 50 onto a part of the substrate 10 on which a lens is to be formed. The molding material M is supplied in an amount necessary for forming a lens 12, onto each part of the substrate on which a lens is to be formed.

FIGS. 4A to 4C are schematic views showing the procedures of forming a lens 12 on a substrate 10 using a mold 60.

After the molding material M is supplied to the substrate 10, and a mold 60 which is used for forming a lens is disposed over the substrate 10 as shown in FIG. 4A. The mold 60 has plural concave portions 62 for transferring the shape of a lens 12, according to a desirable number of the lenses 12.

As shown in FIG. 3, the molding material M is applied dropwise, using the dispenser 50, to portions of the substrate 10 on which the lenses 12 are to be formed. The molding material M in an amount necessary for forming one lens 12 is supplied to each of the portions on which the lenses are to be formed.

After the molding material M is supplied onto the substrate 10, the mold 60 for forming the lens 12 is disposed over the surface of the substrate 10, on which the molding material M has been supplied, as shown in FIG. 4A.

Concave portions 62 for transferring the shape of the lens 12 is provided in the mold 60 according to a desirable number of the lenses 12.

Subsequently, as shown in FIG. 4B, the mold 60 is pressed to the molding material M on the substrate 10, so that the molding material M is deformed according to the shape of the concave portions 62. Then, the molding material M is cured while the mold 60 is pressed to the molding material M, by irradiation of heat or ultraviolet light from the outside of the mold 60 when the molding material M is a thermosetting resin or an ultraviolet curable resin.

As the molding material M is cured, the substrate 10 and lenses 12 are released from the mold 60 as shown in FIG. 4C.

Formation of Light-Shielding Film

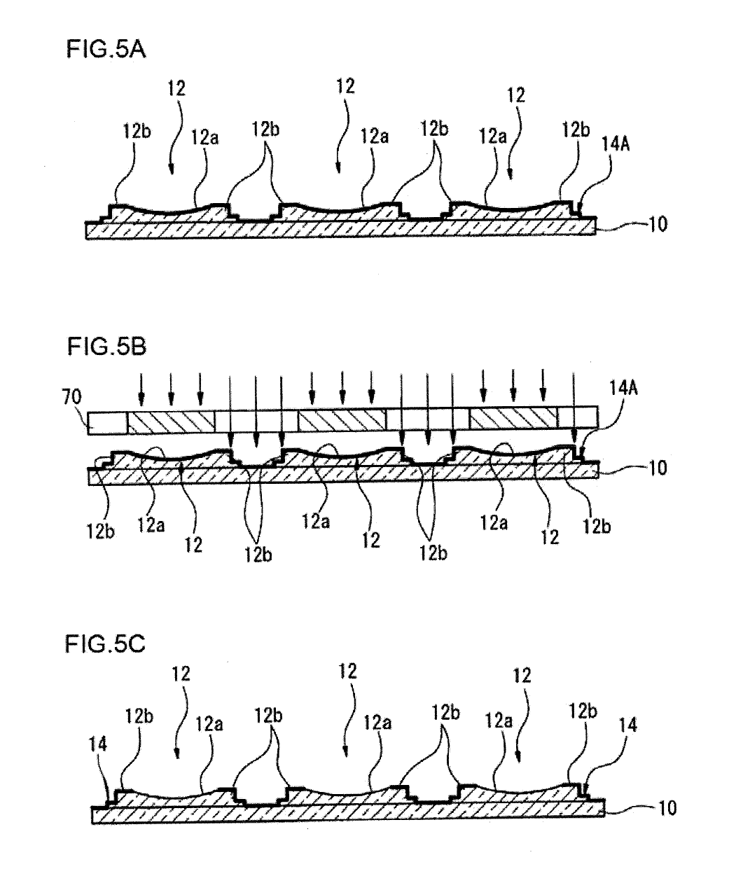

With reference to FIGS. 5A to 5C, a method of forming a light-shielding film 14 in the peripheral portion of the lenses 12 will be described.

FIGS. 5A to 5C are schematic cross-sectional views showing the steps of forming a light-shielding film 14 on the substrate 10 on which lenses 12 have been formed.

In an embodiment, the method of forming a light-shielding film 14 includes: applying the light-shielding curable composition of the invention onto the substrate 10 to form a light-shielding coating layer 14A (hereinafter, may be referred to as “light-shielding coating layer formation step” or “light-shielding curable composition coating layer formation step”) (see FIG. 5A); pattern-exposing the light-shielding coating layer 14A through a mask 16 (hereinafter, may be referred to as “exposure step”) (see FIG. 5B); and developing the light-shielding coating layer 14A after exposure, and removing an uncured portion thereof to form a patterned light-shielding film 14 (hereinafter, may referred to as “development step”) (see FIG. 5C).

The patterned light-shielding film 14 may be arbitrary formed either before or after producing the lens 12. In the following, a method of forming a patterned light-shielding film after a lens 12 has been produced will be described.

Respective steps of the method of forming a light-shielding film 14 will be described below.

Light-Shielding Curable Composition Coating Layer Formation Step

In the light-shielding coating layer formation step, as shown in FIG. 5A, the light-shielding curable composition is applied on the substrate 10 to form a light-shielding coating layer 14A having a low light reflection ratio, which is formed from the light-shielding curable composition. In this case, the light-shielding coating layer 14A is formed so as to cover the surface of the substrate 10 and the lens face 12a of the lens 12 and the surface of the peripheral portion 12b of the lens.

The substrate 10 which can be used in this step is not specifically limited. Examples of the substrate 10 include soda glass, PYREX (registered mark) glass, quartz glass and a transparent resin.

In an embodiment in which the lens 12 and the substrate 10 are integrally formed, the “substrate 10” refers to have a configuration including both the lens 12 and the substrate 10.

On the substrate 10, an undercoating layer may be optionally provided for improvement of adhesion with an upper layer, prevention of diffusion of material or flattening the surface of the substrate 10.

Examples of a method of applying the light-shielding curable composition on the substrate 10 and the lens 12 include various coating methods such as slit coating, spray coating, an inkjet method, spin coating, cast coating, roll coating, or a screen printing method.

A film thickness immediately after applying the light-shielding curable composition is preferably from 0.1 μm to 10 μm, more preferably from 0.2 μm to 5 μm and even more preferably from 0.2 μm to 3 μm, from the viewpoints of thickness uniformity of the coating film, and ease of drying of the coating solvent.

The drying (prebaking) of the light-shielding layer (light-shielding curable composition coating layer) 14A coated on the substrate 10 may be performed using, for example, a hot plate or an oven at a temperature of from 50° C. to 140° C. for 10 seconds to 300 seconds.

The coating film thickness (hereinafter, also referred to as “dry film thickness”) after drying the light-shielding curable composition can be arbitrary selected according to desired performances such as a light-shielding property, and is generally in a range of from 0.1 μm to less than 50 μm.

Exposure Step

In the exposure step, the light-shielding coating layer 14A formed in the light-shielding coating layer formation step is subjected to pattern exposure. The pattern exposure may be performed by scanning exposure, but as shown in FIG. 5B, exposure through a mask 70 having a prescribed mask pattern is preferred.

In the exposure step according to such an embodiment, the coating layer 14A is exposed to light through a mask having a prescribed mask pattern, whereby only a portion irradiated with light is cured in the coating layer 14A. A mask pattern is used through which the surfaces of the lens peripheral portions 12b and the surface of the substrate 10 present between the lenses 12 are irradiated with light. Therefore, only the coating layer 14A present at regions other than the lens faces 12a is cured by light irradiation, and the cured regions form a light-shielding film 14.

As radiation which can be used for the exposure, ultraviolet rays such as g-rays, h-rays, and i-rays are preferably used. The radiation may be from a light source of a single wavelength or may be from a light source including all wavelengths such as a high-pressure mercury vapor lamp.

Development Step

Subsequently, by performing an alkali development treatment (development step), a portion which has not been irradiated by light during the exposure, that is, an uncured portion of the light-shielding coating layer 14A, is eluted into an aqueous alkali solution, and only the cured portions of the light-shielding coating layer 14A remain in the light-irradiated regions.

Specifically, when the light-shielding coating layer 14A exposed as shown in FIG. 5B is developed, only portions of the light-shielding coating layer 14A formed on the lens faces 12a are removed, and a cured light-shielding film 14 is formed in the regions other than the regions from which the light-shielding coating layer 14A is removed, as shown in FIG. 5C.

An alkali agent contained in a developer used in the development step may be any one of an organic alkali agent, an inorganic alkali agent, and a combination of an organic alkali agent and an inorganic alkali agent. It is preferable to use an organic alkali developer in forming the light-shielding film in the invention, from the viewpoints of reduced likelihood of impairing a peripheral circuit.

Examples of the alkali agent used in a developer include: organic alkali compounds such as aqueous ammonia, ethyl amine, diethyl amine, dimethyl ethanol amine, tetramethyl ammonium hydroxide, tetraethyl ammonium hydroxide, choline, pyrrole, piperidine, or 1,8-diazabicylclo-[5,4,0]-7-undecene; and inorganic compounds such as sodium hydroxide, potassium hydroxide, sodium hydrogen carbonate, or potassium hydrogen carbonate. An aqueous alkali solution diluted with pure water is used as the developer, such that the concentration of the alkali agent is from 0.001% by mass to 10% by mass, and preferably from 0.01% by mass to 1% by mass.

Development is carried out at a temperature of from 20° C. to 30° C. for 20 seconds to 90 seconds.

In a case in which a developer formed of the aqueous alkali solution is used, generally an unexposed portion of a coating film is removed by the developer, followed by washing (rinsing) with pure water. In other words, after a development treatment, excess developer is washed away and removed satisfactorily with pure water, and a drying step is subsequently performed.

In an embodiment, the production method may optionally include a step of curing the formed light-shielding pattern by heating (post-baking) and/or exposure, after performing the coating layer formation step, exposure step, and development step.

The post-baking is a heating treatment performed after development, for the purpose of complete curing, and is generally a heat curing treatment at 100° C. to 250° C. The conditions such as temperature and times of post-baking can be suitably set depending on the materials of the substrate or the lens. For example, in a case in which the substrate is a glass, the post-baking temperature is preferably from 180° C. to 240° C.

The post-baking treatment of a light-shielding film 14 formed by the development can be performed in a continuous system or a batch system using a heating apparatus such as a hot plate, a convection oven (hot air circulating dryer) or a radio-frequency heating apparatus so as to have the suitable conditions.

In the above, an embodiment in which the lens 12 has a concave shape is described. However, the shape of the lens is not specifically limited thereto, and the lens may have a convex or aspheric surface. Further, in the above, an embodiment in which a wafer level lens having plural lenses 12 formed on one side of a substrate 10 is described. However, a wafer level lens of the invention may have a configuration in which plural lenses 12 are formed on both sides of a substrate 10, and in this case, light-shielding layers 14 are formed on both sides of the substrate 10 in regions other than the lens faces.

Configuration and Production of Wafer Level Lens (2)

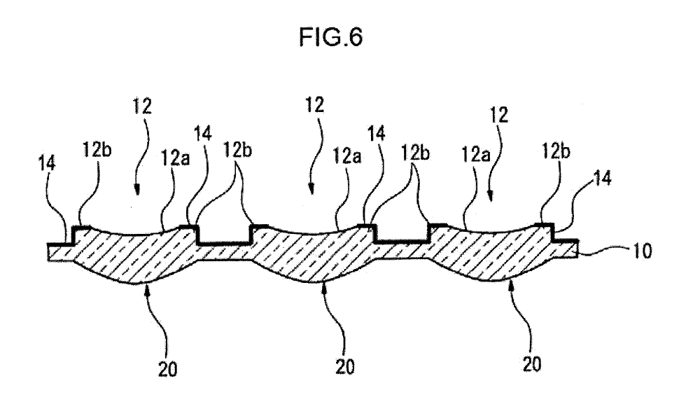

FIG. 6 is a cross-sectional view showing another configuration example of a wafer level lens array.

The wafer level lens array shown in FIG. 6 has a configuration (monolithic type) in which a substrate 10 and lenses 12 are formed at once using the same molding material.

Examples of molding materials used for forming such a wafer level lens array are the same as the molding materials described above. In this embodiment, plural concave lenses 12 are formed on one side (upper side in figure) of the substrate 10, and plural convex lenses 20 are formed on the other side (lower side in figure) of the substrate. A patterned light-shielding film 14 is formed in regions excluding the lens face 12a of the substrate 10; that is, a patterned light-shielding film 14 is formed on the surface of the substrate 10 and the surface of the lens peripheral portions 12b. As a patterning method used for forming the light-shielding film 14, any of the methods described above may be used.

Configuration and Production of Wafer Level Lens (3)

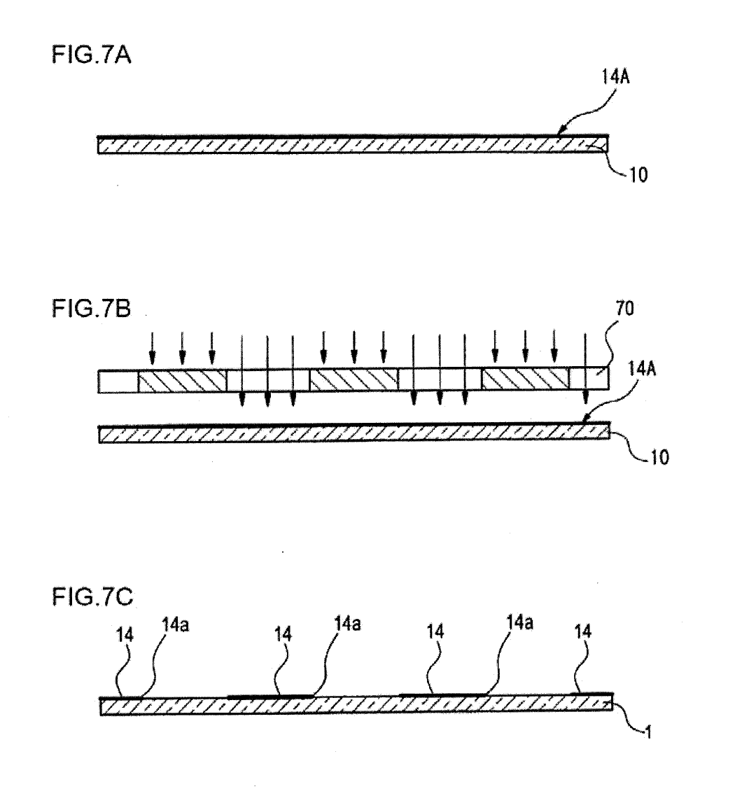

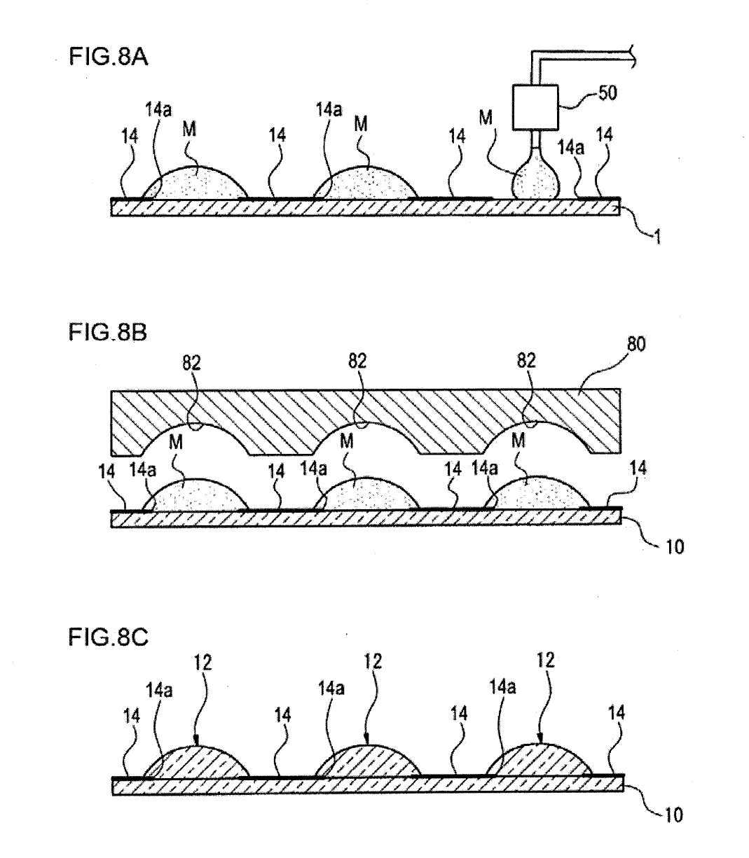

With reference to FIGS. 7A to 7C and FIGS. 8A to 8C, another configuration example of a wafer level lens array and the procedures for producing the same will be described below.

FIGS. 7A to 7C are schematic views showing another embodiment of processes for forming a patterned light-shielding film 14.

FIGS. 8A to 8C are schematic views showing processes of forming lenses 12 after the patterned light-shielding film 14 has been formed.

In the embodiment of the wafer level lens array shown in FIGS. 3 to 6, the patterned light-shielding film 14 is formed on the substrate 10 on which the lenses 12 have been formed. On the other hand, in the embodiment described below, first, a patterned light-shielding film 14 is formed on a substrate 10, and then lenses 12 are formed on the substrate 10.

Formation of Light-Shielding Film

First, as shown in FIG. 7A, a light-shielding curable composition is applied on the substrate 10 to form a light-shielding coating layer 14A (hereinafter, may be referred to as “light-shielding coating layer formation step”).

Thereafter, the light-shielding coating layer 14A applied on the substrate 10 is dried using, for example, a hot plate or an oven at a temperature of from 50° C. to 140° C. for 10 seconds to 300 seconds. The driy film thickness of the light-shielding coating layer can be selected according to desired performances such as a light-shielding property, and is a range of from about 0.1 μm to about less than 50 μm.

Then, as shown in FIG. 7B, the light-shielding coating layer 14A formed in the light-shielding coating layer formation step is pattern-exposed through a mask 70. The mask 70 has a prescribed mask pattern.

During exposure in the present embodiment, the light-shielding coating layer 14 is pattern-exposed, and thus only a portion which is irradiated by light is cured in the light-shielding coating layer 14A. In this embodiment, a mask pattern is used which enables light irradiation at a portion of the light-shielding coating layer 14A in a region excluding the regions which serve as lens apertures 14a of lenses 12 when the lenses 12 are formed in the subsequent processes. In this way, the light-shielding coating layer 14A is cured by light-irradiation excluding portions thereof which are to become the lens apertures 14a of the lenses 12. Examples of radiation which can be used in the exposure preferably include ultraviolet rays such as g-rays, h-rays or i-rays, as in the above embodiments.

Next, by performing an alkali development treatment (developing step), only the light-shielding coating layer 14A in the region corresponding to the lens aperture 14a of the lens 12 which is an uncured region of the light-shielding coating layer 14A in the pattern exposure is eluted by an aqueous alkali solution. At this time, as shown in FIG. 7C, a photocured light-shielding coating layer 14A remains on the substrate 10 except for the region for the lens aperture 14a of the lens 12 to form a light-shielding film 14.

Examples of an alkaline agent included in the aqueous alkali solution serving as a developer are the same as those used in the embodiments described above.

Then, after the developing treatment, excess developer is washed and removed, followed by drying.

In the present embodiment, after performing of the coating layer formation step, exposure step, and developing step, the formed light-shielding film may be optionally cured by post-baking and/or exposure as described above.

Formation of Lens

Next, a step of forming the lenses 12, which is performed after the light-shielding film 14 is formed, will be described.

As shown in FIG. 8A, a molding material M for lenses 12 is applied dropwise using a dispenser 50 onto a substrate 10 on which the patterned light-shielding film 14 has been formed. The molding material M for lenses 12 is supplied so as to cover regions corresponding to the lens apertures 14a of the lenses 12 and so as to also cover a portion of the end of the light-shielding film 14 adjacent to the apertures.

After the molding material M is supplied to the substrate 10, a mold 80 for forming a lens is disposed over the substrate at the side of the substrate 10 where the molding material M has been supplied, as shown in FIG. 8B. The mold 80 has plural concave sections 82 for transferring the shape of lens 12 according to the desirable number of lenses 12.

Then, the mold 80 is pressed onto the molding material M present on the substrate 10, so that the molding material M is deformed according to the shape of the concave sections. The molding material M is cured while the mold 80 is pressed onto the molding material M, by irradiation of heat or ultraviolet light from the outside of the mold when the molding material M is a thermosetting resin or an ultraviolet curable resin.

After the molding material M is cured, the substrate 10 and the lens 12 are released from the mold 80, thereby obtaining a wafer level lens array having a patterned light-shielding film 14 on the substrate 10, as shown in FIG. 8C.

As described above, the patterned light-shielding film 14 to be provided in a wafer level lens is formed not only in a region excluding the lens faces 10a of the lenses 12 as shown in FIG. 2, but the light-shielding film 14 may also be provided in a region excluding the lens apertures 14a of the lenses 12 as shown in FIG. 8C.

In the wafer level lens, generation of reflected light can be inhibited while light-shielding is sufficiently performed in a region other than at the lens face 12a or the lens aperture 14a of the lens 12 by the use of a light-shielding film 14 having a low light reflection ratio which is pattern-formed on at least one side of the substrate 10. Therefore, in a case in which the wafer level lens is applied to an imaging module having an imaging device, defects such as ghosting or flare caused by reflected light during imaging can be prevented.

Further, since the light-shielding film 14 is provided on the surface of the substrate, other light-shielding members need not be placed in the wafer level lens, and increases in production costs can be suppressed.

Further, as in the configuration described in International Application Publication No. 2008/102648 described above, in a case in which the surface around the lens has a concave and convex structure, incident light on the structure is reflected or diffused, and thus there is a risk of causing defects such as ghosting. In this regard, as shown in FIG. 2, when the patterned light-shielding film 14 is provided in a region excluding the lens face 10a of the lens 12, light can be shielded other than at the lens face 10a and the optical performance can be improved.

Color Filter

The color filter of the invention has a light-shielding section (or a black matrix) formed using the light-shielding curable composition.

The color filter has at least a light transmissive substrate and a colored layer on the light transmissive substrate including two or more pixel groups expressing different colors, in which respective pixels forming the pixel groups are separated by a black matrix. The black matrix is produced using the light-shielding curable composition of the invention. The number of pixel groups may be 2, 3, or 4 or more. For example, in the case of 3 pixel groups, the three colors red (R), green (G) and blue (B) are used. When 3 pixel groups of red, green, and blue are arranged, an arrangement such as a mosaic type or a triangle type is preferred. When 4 or more pixel groups are arranged, any arrangement may be used.

As the light transmissive substrate, a known glass plate such as a soda glass plate having a silicon oxide film on the surface thereof, a low expansion glass plate, a non-alkali glass plate, or a quartz glass plate, or a plastic film may be used.

For producing a color filter, two or more pixel groups are formed by a conventional method on the light transmissive substrate, and the light-shielding curable composition is then applied to a portion of the substrate which is to be separated by a black matrix, followed by performing pattern exposure and development, or, first, the black matrix is formed and then two or more pixel groups may be formed.

### EXAMPLES

The invention is described in detail by referring to Examples, but the invention is not limited to the following Examples unless departing from the spirit of the invention. In the following, unless otherwise specified, “%” means “% by mass” and “part” means “part by mass”.

### Synthesis Example 1

### Synthesis of Resin (P1)

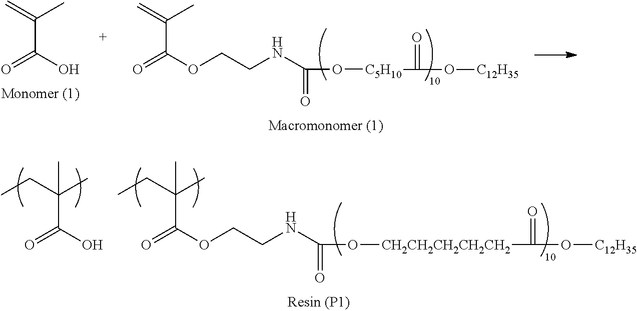

First, 30 g of Monomer (1) (0.35 mol) (methacrylic acid, manufactured by Wako Pure Chemical Industries, Ltd.), and 70 g (0.047 mol; mass average molecular weight by GPC in terms of polystyrene: 3,100) of Macromonomer (1) were added to 233 g of 1-methoxy-2-propanol, followed by heating at 80° C. under nitrogen airflow. Subsequently, 1.54 g (7.6 mmol) of dodecanethiol, and 0.50 g of dimethyl 2,2′-bisisobutyrate (V-601 (trade name), manufactured by Wako Pure Chemical Industries, Ltd.) were added thereto, followed by stirring for 2 hours. Subsequently, 0.50 g of dimethyl 2,2′-bisisobutyrate (V-601 (trade name), manufactured by Wako Pure Chemical Industries, Ltd.) were added thereto, followed by stirring for additional 2 hours. Then, 0.50 g of dimethyl 2,2′-bisisobutyrate (V-601 (trade name), manufactured by Wako Pure Chemical Industries, Ltd.) were added thereto, and the temperature was raised to 90° C., followed by stirring for 2 hours, thereby obtaining a 30% 1-methoxy-2-propanol solution of resin (P1), which is a (B) dispersant having a polyester structure according to the invention. Resin (P1) had a mass average molecular weight measured by GPC of 25,000, a number average molecular weight measured by GPC of 11,000, and an acid value of 190 mgKOH/g.

### Synthesis Examples 2 to 6

### Synthesis of Resins (P2) to (P5) and Comparative Resin P1

Resins (P2) to (P5), which are (B) dispersants having a polyester structure according to the invention, and Comparative resin P1 were obtained in the same manner as Synthesis Example 1, except that the monomers and macromonomers described in Table 1 were used.

TABLE 1

| | | Acid group- | | Mass average | Number average | Acid value |
|---|---|---|---|---|---|---|
| | | containing monomer | Macromonomer | molecular weight | molecular weight | (mg KOH/g) |
| Synthesis | Resin (P1) | Monomer (1) 30 g | Macromonomer (1) | 25,000 | 11,000 | 195 |
| Example 1 | | | 70 g | | | |
| Synthesis | Resin (P2) | Monomer (1) 30 g | Macromonomer (2) | 27,000 | 12,000 | 193 |
| Example 2 | | | 70 g | | | |
| Synthesis | Resin (P3) | Monomer (2) 30 g | Macromonomer (1) | 24,000 | 13,000 | 150 |
| Example 3 | | | 70 g | | | |
| Synthesis | Resin (P4) | Monomer (3) 30 g | Macromonomer (1) | 27,000 | 14,000 | 82 |
| Example 4 | | | 70 g | | | |
| Synthesis | Resin (P5) | Monomer (1) 15 g | Macromonomer (1) | 22,000 | 10,000 | 170 |
| Example 5 | | Monomer (2) 15 g | 70 g | | | |
| Synthesis | Comparative | Monomer (3) 30 g | Macromonomer (3) | 31,000 | 14,000 | 80 |
| Example 6 | Resin P1 | | 70 g | | | |

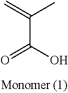

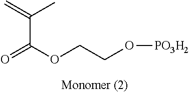

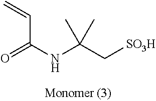

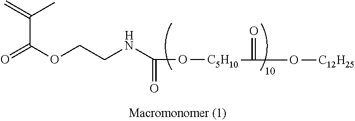

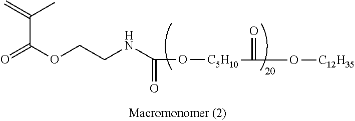

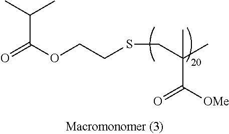

### Synthesis Example 7

### Synthesis of Resin (P6)

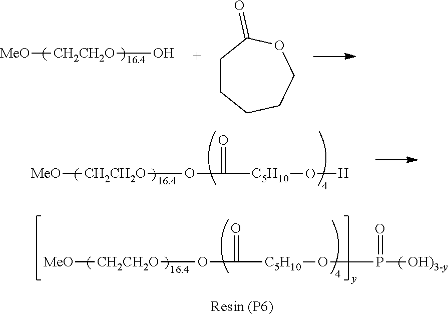

Under a nitrogen atmosphere, 112.5 g (0.15 mol) of polyethylene glycol monomethyl ether having a number average molecular weight of 750, 68.4 g (0.60 mol) of ε-caprolactone and 0.18 g of dibutyltin laurate were heated at 160° C. for 20 hours to obtain monohydroxy polyether-polyester form. The mass average molecular weight measured by GPC was 2,300 and the number average molecular weight measured by GPC was 1,100. Subsequently, 7.0 g of polyphosphoric acid containing 84% phosphorus pentoxide was added to 100 g of the obtained monohydroxy polyether-polyester form, and reacted therewith at 80° C. for 5 hours while removing moisture, thereby obtaining Resin (P6). Resin (P6) had a mass average molecular weight measured by GPC of 2,500 and a number average molecular weight measured by GPC of 1,200. In Resin (P6), the ratio of phosphoric acid monoester and phosphoric acid diester (phosphoric acid monoester:phosphoric acid diester) was determined by ³¹P NMR to be 88:12.

### Synthesis Example 7

### Synthesis of Polymerizable Compound (M1)

In a 3L-three necked flask, 370 g of 2-hydroxyethyl acrylate, 730 g of s-caprolactone, 0.40 g of 4-methoxyphenol and 0.50 g of phosphoric acid (98 w/w %) were charged, followed by heating at 120° C. After confirming by liquid chromatography that the reactivity of the ε-caprolactone was less than 99% in 8 hours, the solution was cooled to room temperature, thereby obtaining a pale yellow liquid precursor A 1 (having the following structure). It was confirmed by ¹H-NMR and mass spectrometry that the product was A1.

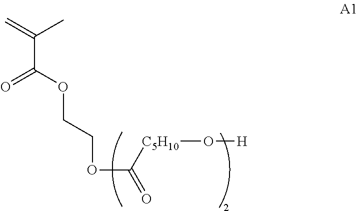

Then, 18.1 g of adipoyl chloride and 180 mL of methylene chloride were charged, and the temperature was adjusted to 25° C., followed by stirring. Subsequently, a mixture containing 71.6 g of precursor A1, 42.8 mL of triethyl amine, 0.36 g of 4-dimethyl aminopyridine, 0.01 g of 4-methoxyphenol and 300 mL of methylene chloride was added dropwise thereto. Subsequently, the reaction mixture was washed three times with 800 mL of an aqueous mixed solution containing 88 g of water, 2 g of phosphoric acid, 5 g of sodium hydrogen carbonate and 5 g of salt, and solvent was evaporated under reduced pressure, thereby obtaining a pale yellow liquid polymerizable compound M1 having the following structure ((C) polymerizable compound having a polyester structure according to the invention) as a residue.

### Synthesis Examples 8 to 11

### Synthesis of Polymerizable Compounds (M2) to (M5)

Polymerizable compounds (M2) to (M5) ((C) polymerizable compounds having a polyester structure according to the invention) shown below were synthesized in the same manner as the synthesis method of the specific compound M1, except that the constitutent of the specific compound M1 was changed.

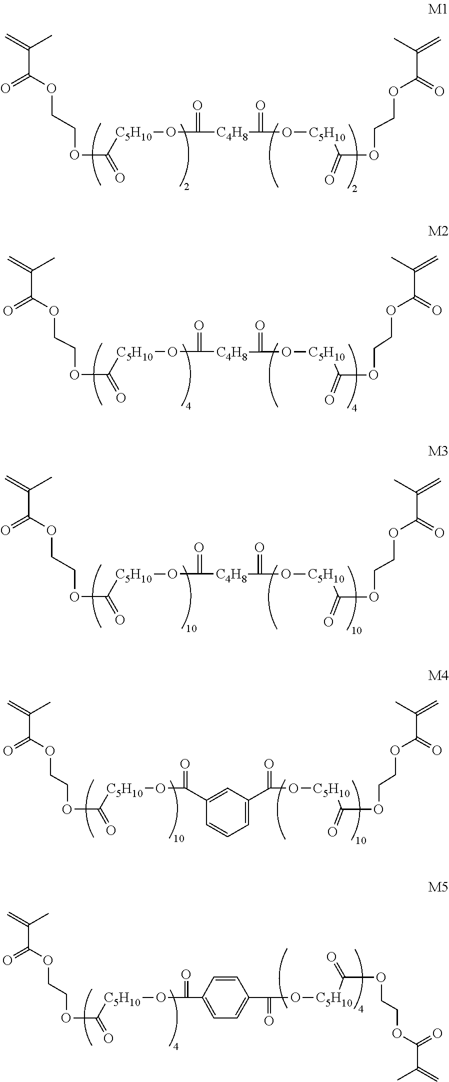

### Synthesis Example 12

### Synthesis of Polymerizable Compound (M6)

In a 500 mL-three necked flask, 600 g of ε-caprolactone and 100 g of 1,3-propanediol were introduced and stirred and dissolved while blowing nitrogen therein. Then, 0.1 g of monobutyltin oxide was added thereto, followed by heating to a temperature of 100° C. After confirming by liquid chromatography that the raw materials were eliminated in 8 hours, the solution was cooled to a temperature of 80° C. Then, 0.1 g of 2,6-di-t-butyl-4-methyl phenol followed by 27.2 g of 2-methacryloyloxyethyl isocyanate were added. After confirming by ¹H-NMR that the raw materials were eliminated in 5 hours, the solution was cooled to room temperature, thereby obtaining a liquid of polymerizable compound (M6) having the following structure ((C) polymerizable compound having a polyester structure according to the invention). It was confirmed by ¹H-NMR and mass spectrometry that the product was Exemplary Compound M6.

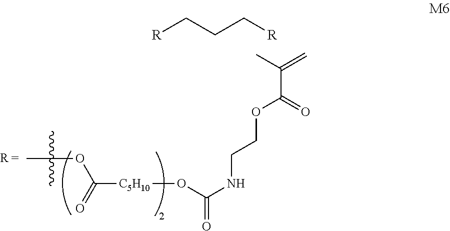

### Synthesis Example 13

### Synthesis of Polymerizable Compound (M7)

Polymerizable compound M7 shown below ((C) polymerizable compound having a polyester structure according to the invention) was synthesized in the same manner as the synthesis method of polymerizable compound M6 except that the constituent of polymerizable compound M6 was changed.

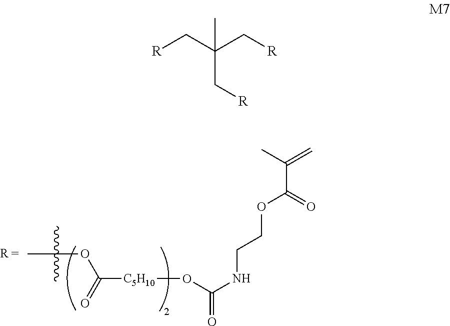

### Preparation of Pigment Dispersion Liquid 1

The components represented by the following composition I were subjected to high viscosity dispersion treatment using a twin roll to obtain a dispersion. Furthermore, the components may be kneaded with a kneader for 30 minutes before high viscosity dispersion treatment.

Composition I
Titanium black (average primary particle size of 40 nm; (A) inorganic pigment): 40 parts (Pigment Black 35 (trade name), manufactured by Mitsubishi Materials Corporation)
30% Propylene glycol-1-monomethylether-2-acetate solution of Resin (P1) [(B) dispersant having a polyester structure and (E) solvent]: 5 parts

The components represented by the following composition II were added to the obtained dispersion, and stirring using a homogenizer was carried out at 3,000 rpm for 3 hours. The mixed solution thus obtained was subjected to a dispersion treatment using a disperser (DISPERMAT (trade name), manufactured by Getzmann) employing 0.3 mm-zirconia beads for 4 hours, thereby obtaining Pigment dispersion liquid 1.

Composition II
30% Propyleneglycol-1-monomethylether-2-acetate solution of Resin (P1) [(B) dispersant having a polyester structure and (E) solvent]: 20 parts
Propyleneglycol monomethyl ether acetate [(E) solvent]: 150 parts

Preparation of Pigment Dispersion Liquids 2 to 7

Pigment dispersion liquids 2 to 7 were prepared in the same manner as the preparation of Pigment dispersion liquid 1, except that Resin (P1) used in the composition I and composition II was replaced with Resin (P2), Resin (P3), Resin (P4), Resin (P5), Resin (P6), or Comparative resin (P1), respectively.

### Preparation of Light-Shielding Curable Composition 1

The following components were mixed using a stirrer, followed by filtration using HDC II (trade name, manufactured by Pall Corporation) at high density polypropylene filtration accuracy of 6.0 μm, to prepare Light-shielding curable composition 1 according to the invention.
30% Propyleneglycol-1-monomethylether-2-acetate solution of benzyl methacylate/methyl methacylate/hydroxyethyl methacylate/acrylic copolymer (50/15/5/30 [molar ratio]) [alkali soluble resin, binder polymer]: 10 parts
Polymerizable compound (M2) [(C) polymerizable compound having a polyester structure]: 2.0 parts
Polymerizable compound (dipentaerythritol hexaacrylate): 2.0 parts
IRGACURE OXE01 (trade name) (manufactured by Ciba Specialty Chemicals [(D) polymerization initiator]: 0.3 parts
Pigment dispersion 1 prepared above: 24 parts
Ethyl-3-ethoxypropionate [(E) solvent]: 8 parts

Preparation of Light-Shielding Curable Compositions 2 to 18

Light-shielding curable compositions 2 to 18 were prepared in the same manner as in the preparation of Light-shielding curable composition 1, except that the pigment dispersion liquids and the polymerizable compounds shown in Table 2 were used. Light-shielding curable compositions 2 to 16 were the light-shielding curable compositions according to the invention, and Light-shielding curable compositions 17 and 18 were comparative light-shielding curable compositions.

### Preparation of Light-Shielding Curable Composition 19

15 g of tin colloid (average particle diameter: 20 nm, solid content: 20%, manufactured by Sumitomo Osaka Cement Co., Ltd.), 60 g of silver colloid (average particle diameter: 7 nm, solid content: 20% by weight, manufactured by Sumitomo Osaka Cement Co., Ltd.) and 0.75 g of polyvinyl pyrrolidone were dissolved in 100 mL of water, and the resultant solution was added to 200 mL of pure water with a temperature maintained to 60° C. to obtain a colloidal solution.

Subsequently, the colloidal solution was stirred for 60 minutes at state with the temperature maintained to 60° C., followed by application of ultrasonic wave for 5 minutes. Subsequently, the colloid solution was concentrated by centrifugation to obtain Liquid A having a 25% solid content. The liquid A was dried by freeze-drying to obtain a powder sample.

Pigment dispersion liquid 8 was prepared in the same manner as in the preparation of Pigment dispersion liquid 1, except that the titanium black was replaced with the powder sample. Subsequently, Light-shielding curable composition 19 according to the invention was prepared in the same manner as in the preparation of Light-shielding curable composition 1 except that Pigment dispersion liquid 8 was used.

Preparation of Red Pigment Dispersion Liquid

The following composition was subjected to a dispersion treatment using a disperser (Trade name: DISPERMAT, manufactured by Getzmann) using zirconia beads having a diameter of 0.3 mm for 4 hours to obtain Pigment dispersion liquid 9.
C.I. Pigment Red 254 [(F) colorant component]: 30 parts
Resin solution (benzyl methacylate/methacylic acid/hydroxyethyl methacylate copolymer, molar ratio: 80/10/10, mass average molecular weight Mw: 10,000, solvent:60% propylene glycol methyl ether acetate, resin solid concentration: 40%): 10 parts
Solvent: propylene glycol methyl ether acetate: 200 parts
Dispersant: Resin (P1) (30% propylene glycol-1-methylether-2-acetae solution): 30 parts

Preparation of Pigment Dispersion Liquid 9

Pigment dispersion liquid 9 was prepared in the same manner as in the preparation of Pigment dispersion liquid 1, except that Pigment dispersion liquid 1 was replaced with a mixture of 20 parts of Pigment dispersion liquid 1 and 9 parts of the red pigment dispersion liquid.

Preparation of Light-shielding Curable Composition 20

Light-shielding curable composition 20 of the invention was prepared in the same manner as in the preparation of Light-shielding curable composition 1, except that Pigment dispersion liquid 1 was replaced with Pigment dispersion liquid 9.

TABLE 2

| | Light-shielding | | | | | |
|---|---|---|---|---|---|---|
| | curable | Pigment dispersion liquid | | | | |
| | composition | | Pigment | Dispersant | Polymerizable compound | |
| Example 1 | 1 | 1 | Titanium black | Resin (P1) | M2 2.0 parts | M8 2.0 parts |
| Example 2 | 2 | 2 | Titanium black | Resin (P2) | M2 2.0 parts | M8 2.0 parts |
| Example 3 | 3 | 3 | Titanium black | Resin (P3) | M2 2.0 parts | M8 2.0 parts |
| Example 4 | 4 | 4 | Titanium black | Resin (P4) | M2 2.0 parts | M8 2.0 parts |
| Example 5 | 5 | 5 | Titanium black | Resin (P5) | M2 2.0 parts | M8 2.0 parts |
| Example 6 | 6 | 6 | Titanium black | Resin (P6) | M2 2.0 parts | M8 2.0 parts |
| Example 7 | 7 | 1 | Titanium black | Resin (P1) | M1 2.0 parts | M8 2.0 parts |
| Example 8 | 8 | 1 | Titanium black | Resin (P1) | M3 2.0 parts | M8 2.0 parts |
| Example 9 | 9 | 1 | Titanium black | Resin (P1) | M4 2.0 parts | M8 2.0 parts |
| Example 10 | 10 | 1 | Titanium black | Resin (P1) | M5 2.0 parts | M8 2.0 parts |
| Example 11 | 11 | 1 | Titanium black | Resin (P1) | M6 2.0 parts | M8 2.0 parts |
| Example 12 | 12 | 1 | Titanium black | Resin (P1) | M7 2.0 parts | M8 2.0 parts |
| Example 13 | 13 | 1 | Titanium black | Resin (P1) | M1 4.0 parts | — |
| Example 14 | 14 | 1 | Titanium black | Resin (P1) | M7 4.0 parts | — |
| Example 15 | 15 | 1 | Titanium black | Resin (P1) | M9 4.0 parts | — |
| Example 16 | 16 | 1 | Titanium black | Resin (P1) | M10 2.0 parts | M8 2.0 parts |
| Comparative | 17 | 7 | Titanium black | Comparative | M2 2.0 parts | M8 2.0 parts |
| Example 1 | | | | Resin P1 | | |
| Comparative | 18 | 1 | Titanium black | Resin (P1) | M9 2.0 parts | M8 2.0 parts |
| Example 2 | | | | | | |
| Example 17 | 19 | 8 | Silver-tin | Resin (P1) | M2 2.0 parts | M8 2.0 parts |
| Example 18 | 20 | 9 | Titanium black and | Resin (P1) | M2 2.0 parts | M8 2.0 parts |
| | | | PR254 | | | |

Polymerizable compound M8 shown in Table 2 was dipentaerythritol hexacrylate, Polymerizable compound M9 was KAYARAD DPCA-60 (trade name, manufactured by Nippon Kayaku Co., Ltd.), Polymerizable compound M10 was KAYARAD HX-220 (trade name, manufactured by Nippon Kayaku Co., Ltd.), and Polymerizable compound M11 was ethoxylated pentaerythrithol tetraacrylate. KAYARAD DPCA-60 and KAYARAD HX-220 have structures described in the explanation of the polymerizable compound having a caprolactone structure, which is represented by Formula (11).

Production and Evaluation of Light-Shielding Film for Wafer Level Lens

Lens film was formed by the following treatment.

### 1. Formation of Thermosetting Resin Film

Curable compositions 1 to 4 (2 mL) shown in Table 3 were applied respectively on 5×5 cm glass substrates (thickness of 1 mm, BK7 (trade name) manufactured by Schott Corporation) and heated and cured at 200° C. for 1 minute, to form films (Resin films 1 to 4) capable of being subjected to evaluation of residues on the lens.

### 2. Formation of Photocurable Resin Film

Curable compositions 5 and 6 (2 mL) shown in Table 3 were applied respectively on 5×5 cm glass substrates and cured by light-irradiation using a metal halide lamp at 3,000 mJ/cm² to form films (Resin films 5 to 6) capable of being subjected to evaluation of residues on the lens.

TABLE 3

| | Lens- | | | |
|---|---|---|---|---|
| | forming | | | |
| | curable | | | |
| Resin film | composition | Component 1 | Component 2 | Kinds of resin film |
| Resin film 1 | 1 | DOW CORNING (R) SR 7010 (trade name) | — | Thermosetting silicon |
| | | (manufactured by Dow Corning Toray | | resin film |
| | | Corporation) | | |
| Resin film 2 | 2 | 1,10-decanediol diacrylate | di-t-butyl peroxide | Thermosetting acryl resin |
| | | (manufactured by Shin-nakamura Chemical | (1% by mass) | film |
| | | Co., Ltd., NK ESTER A-DOG (trade name)) | | |
| Resin film 3 | 3 | Alicyclic bisphenol A liquid epoxy resin | — | Thermosetting epoxy resin |
| | | (manufactured by Japan Epoxy Resin Co., | | film |
| | | Ltd, YX8000 (trade name)) | | |
| Resin film 4 | 4 | Polydiallyl phthalate | — | Thermosetting allyl resin |
| | | (manufactured by Showa Denko K.K., | | film |
| | | BA901 (trade name)) | | |
| Resin film 5 | 5 | Trimethylolpropane tri(meth)acrylate | 1-hydroxycyclohexyl phenyl | Photocurable acryl resin |
| | | (manufactured by Toagosei Co., Ltd, | ketone | film |
| | | ARONIX M-309 (trade name)) | (0.1% by mass) | |
| Resin film 6 | 6 | Alicyclic epoxy resin | Aryl sulfonium salt derivative | Photocurable epoxy resin |
| | | (manufactured by Daicel Chemical Industries | (manufactured by ADEKA | film |
| | | Ltd., EHPE-3150 (trade name)) | Corporation, SP-172 (trade name)) | |
| | | | (1% by mass) | |

### 3. Evaluation on Lens

The revolving speed of spin coating is adjusted so that the thickness of the coated and heated film was 2.0 μm, the light-shielding curable compositions 1 to 18 were coated homogeneously on a glass wafer [support] and a lens film was formed, which was heated by a hot plate at a surface temperature of 120° C. for 120 seconds. Thus, a coated film [light-shielding curable composition layer] having a thickness of 2.0 μm was obtained.

Exposure Step

Subsequently, the obtained coated layer was exposed to an amount of 500 mJ/cm² using a high pressure mercury lamp through a photomask having a hole pattern of 10 mm.

Developing Step

The coated layer after exposure was paddle-developed, using aqueous 0.3% tetramethyl ammonium hydroxide solution at a temperature of 23° C. for 60 seconds, subsequently rinsed using a spin shower, and further washed with pure water to obtain a patterned light-shielding film.

Storage Stability (Stability Over Time) Evaluation

After respective light-shielding curable compositions were stored at room temperature for 1 month, the degree of precipitation of titanium black was evaluated according to the following criteria. The amount of titanium black precipitated was calculated from the absorbance variation of the polymerizable composition diluted 1,000 times with propylene glycol monomethyl ether acetate with a visible light absorption spectrophotometer (CARY-5 (trade name), manufactured by Varian Corporation) and the higher the absorbance variation was, the higher the degree of precipitation is. Furthermore, allowable range was less than 5%.

### Criteria

A: precipitation of titanium black of from 0% to less than 2% was observed
B: precipitation of titanium black of from 2% to less than 5% was observed
C: precipitation of titanium black of from 5% or more was observed

Evaluation of Developing Property on Lens

A developing section having a hole pattern of 10 mm was observed by SEM and the amount of residue was determined. The lower the amount of residue is, the better is th developing property.

Evaluation of Pattern Edge Shape

The pattern edge shape of the light-shielding film were observed with SEM. Evaluation criteria are as follows.

### Evaluation Criteria

A: The peripheral portion was fine.
B: The peripheral portion was less fine, but there were no practical issues.
C: The peripheral portion was not fine.

Light-Shielding Property Evaluation

With respect to a light-shielding property, the transmittance was a maximum with a thickness of 2 μm at wavelength of 400 nm to 800 nm. The lower the value was, the better the value. Transmittance less than 1% was good.

TABLE 4

| | Light-shielding curable | | | | | | Light-shielding |
|---|---|---|---|---|---|---|---|
| Wafer level | composition | | Used resin | Storage | | | property |
| lens | | Remark | film | stability | residue | pattern | (transmittance: %) |
| Example 19 | 1 | Example 1 | resin film 1 | A | 1 | A | 0.6 |
| Example 20 | 2 | Example 2 | resin film 1 | A | 2 | A | 0.6 |
| Example 21 | 3 | Example 3 | resin film 1 | A | 1 | A | 0.6 |
| Example 22 | 4 | Example 4 | resin film 1 | A | 1 | A | 0.6 |
| Example 23 | 5 | Example 5 | resin film 1 | A | 4 | A | 0.6 |
| Example 24 | 6 | Example 6 | resin film 2 | B | 5 | A | 0.6 |
| Example 25 | 7 | Example 7 | resin film 6 | A | 1 | A | 0.6 |
| Example 26 | 8 | Example 8 | resin film 1 | A | 4 | A | 0.6 |
| Example 27 | 9 | Example 9 | resin film 1 | A | 4 | A | 0.6 |
| Example 28 | 10 | Example 10 | resin film 2 | A | 3 | B | 0.6 |
| Example 29 | 11 | Example 11 | resin film 4 | A | 0 | A | 0.6 |
| Example 30 | 12 | Example 12 | resin film 1 | A | 1 | A | 0.6 |
| Example 31 | 13 | Example 13 | resin film 6 | A | 2 | A | 0.6 |
| Example 32 | 14 | Example 14 | resin film 3 | A | 1 | A | 0.6 |
| Example 33 | 15 | Example 15 | resin film 1 | A | 0 | A | 0.6 |
| Example 34 | 16 | Example 16 | resin film 1 | A | 1 | A | 0.6 |
| Example 35 | 19 | Example 17 | resin film 1 | A | 1 | A | 0.4 |
| Example 36 | 20 | Example 18 | resin film 5 | A | 1 | A | 0.4 |
| Comparative | 17 | Comparative | resin film 1 | B | 4 | C | 0.6 |
| Example 3 | | Example 1 | | | | | |
| Comparative | 18 | Comparative | resin film 1 | B | 10 | C | 0.6 |
| Example 4 | | Example 2 | | | | | |

From the results of Table 4, it can be concluded that, in the light-shielding curable compositions 1 to 16, 19 and 20 according to the invention, a cured film having an excellent light-shielding property was obtained, and the developing property and pattern edge formability were excellent. It can be concluded that the wafer level lens which has a light-shielding section in the peripheral portion of the lens produced by using the light-shielding curable composition of the invention, has good performance.

Further, it can be concluded that when titanium black and red organic pigment was combined, and thus the light-shielding property was improved (Examples 18 and 36).

It can be concluded that, Comparative Examples 1 and 3 using the light-shielding curable composition 17 using a dispersant not having a polyester structure and Comparative Examples 2 and 4 using the light-shielding curable composition 18 using the polymerizable compound not containing a polyester structure have a poor developing property and pattern edge formability. It can be concluded that the wafer level lens having a light-shielding section in the peripheral portion of the lens produced by using the light-shielding curable compositions 17 or 18 became a wafer level lens with a deteriorated light-shielding section with a pattern edge shape affected by residue.

Production of Color Filter Having Black Matrix

### Formation of Black Matrix

The revolving speed of spin coating is adjusted so that the light-shielding curable compositions described above were coated on a glass wafer by spin coating such that the thickness of the coated and heated film was 2.0 μm, and were heated by a hot plate at a temperature of 120° C. for 2 minutes to obtain a light-shielding curable composition coating layer.

Subsequently, the obtained coated layer was exposed to an amount of 500 mJ/cm² using i-ray stepper through a photomask having an island pattern of 0.1 mm.

The photosensitive layer after exposure was paddle-developed, using 0.3% aqueous tetramethylammonium hydroxide solution at 23° C. for 60 seconds, subsequently rinsed with a spin shower and washed with pure water to obtain a patterned light-shielding film.

Residue Evaluation (Developing Property Evaluation)

In the exposure step, the residue of the region (uncured section) which was not irradiated with light was observed by SEM and the residue was evaluated. Evaluation criteria were as follows.

### Evaluation Criteria

A: In uncured section, the residue was hardly observed
B: In uncured section, the residue was slightly observed, but there was no practical issues.
C: In uncured section, pronounced residue was observed.

Evaluation of Pattern Edge Shape

The pattern edge shape of the light-shielding film was observed by SEM. Evaluation criteria were as follows.

### Evaluation Criteria

A: The peripheral portion was fine.
B: The peripheral portion was less fine, but there were no practical issues.
C: The peripheral portion was not fine.

Light-Shielding Property Evaluation

With respect to a light-shielding property, transmittance was at a maximum with a thickness of 2 μm at a wavelength of 400 nm to 800 nm. The lower the value was, the better the value. Transmittance less than 1% was good.

TABLE 5

| | Light-shielding | | | | |
|---|---|---|---|---|---|
| | curable | | | | Light-shielding |
| | composition | | | | property |
| Black matrix | | Remark | Residue | pattern | (transmittance: %) |
| Example 37 | 1 | Example 1 | A | A | 0.6 |
| Example 38 | 2 | Example 2 | A | A | 0.6 |
| Example 39 | 3 | Example 3 | A | A | 0.6 |
| Example 40 | 4 | Example 4 | A | A | 0.6 |
| Example 41 | 5 | Example 5 | A | A | 0.6 |
| Example 42 | 6 | Example 6 | A | A | 0.6 |
| Example 43 | 7 | Example 7 | A | A | 0.6 |
| Example 44 | 8 | Example 8 | A | A | 0.6 |
| Example 45 | 9 | Example 9 | A | A | 0.6 |
| Example 46 | 10 | Example 10 | A | B | 0.6 |
| Example 47 | 11 | Example 11 | A | A | 0.6 |
| Example 48 | 12 | Example 12 | A | A | 0.6 |
| Example 49 | 13 | Example 13 | A | A | 0.6 |
| Example 50 | 14 | Example 14 | A | A | 0.6 |
| Example 51 | 15 | Example 15 | A | A | 0.6 |
| Example 52 | 16 | Example 16 | A | A | 0.6 |
| Example 53 | 19 | Example 17 | A | A | 0.4 |
| Example 54 | 20 | Example 18 | A | A | 0.4 |
| Comparative | 17 | Comparative | B | C | 0.6 |
| Example 5 | | Example 1 | | | |
| Comparative | 18 | Comparative | B | C | 0.6 |
| Example 6 | | Example 2 | | | |

From the results of Table 5, it can be concluded that the black matrix using the light-shielding curable composition of the invention has a good developing property, pattern shape and excellent light-shielding property, with respect to Comparative Example 5 using the light-shielding curable composition 17 in which a titanium black is dispersed using a dispersant not having a polyester structure.

When titanium black and red organic pigment are combined, the light-shielding property is further improved (Example 54).

Further, the black matrix using the light-shielding curable composition of the invention has a good developing property and pattern shape and excellent light-shielding property, with respect to using Comparative Example 6 using the light-shielding curable composition in which titanium black is dispersed using only the polymerizable composition not having a polyester structure

Preparation of Chromatic Colored Polymerizable Composition

In the light-shielding curable composition produced in Example 1, a colored polymerizable composition R-1 for red (R), a colored polymerizable composition G-1 for green (G), and a colored polymerizable composition B-1 for blue (B) were prepared in the same manner as Example 1 except that a titanium black as a black pigment was replaced with the following chromatic pigments.

### RGB Respective Colors Colored Pixel-Forming Organic Pigment

Red (R) pigment: C.I. PIGMENT RED 254 (trade name)
Green (G) Pigment: mixture of 30/70 [mass ratio] of C.I. PIGMENT GREEN 36 (trade name) and C.I. PIGMENT YELLOW 219 (trade name)
Blue (B) pigment: mixture of 30/70 [mass ratio] of C.I. PIGMENT BLUE 15:6 (trade name) and C.I. PIGMENT VIOLET 23 (trade name)

Production of Color Filter

The light-shielding filter produced in Example 1 was used as a black matrix, and a colored pattern of red (G) of 80×80 μm was formed in the same manner as the method described in Example 1 using the colored polymerizable composition R-1 for red (R) on the black matrix. A chromatic colored pattern of green (G) was similarly formed using the colored polymerizable composition G-1 for green (G) and subsequently a chromatic colored pattern of blue (B) was formed using the colored polymerizable composition B-1 for blue (B) to produce a color filter having a black matrix for liquid crystal display.

Evaluation

Processing such as ITO transparent electrode or alignment film was performed with full color in the color filter and a liquid crystal display was provided. The polymerizable compound of the invention had good uniformity with respect to the coated face, and the liquid crystal display had no display unevenness and image quality was good.

1. A light-shielding curable composition, comprising:
an inorganic pigment;
a dispersant having a polyester structure;
a polymerizable compound having a polyester structure;
a polymerization initiator; and
a solvent.

2. The light-shielding curable composition according to claim 1, wherein a value M/v, obtained by dividing the molecular weight (M) of the polymerizable compound having a polyester structure by the number (v) of polymerizable groups in a molecule of the polymerizable compound having a polyester structure, is in a range of from 100 to 3000.

3. The light-shielding composition according to claim 1, wherein the polymerizable compound having a polyester structure comprises polycaprolactone as the polyester structure.

4. The light-shielding curable composition according to claim 1, wherein the inorganic pigment comprises titanium black.

5. The light-shielding curable composition according to claim 1, wherein the dispersant having a polyester structure comprises a copolymer of a monomer having an acidic group having a pKa of 6 or less and a macromonomer which is represented by the following Formula (1) or Formula (2) and which has a mass average molecular weight of 1,000 or more: 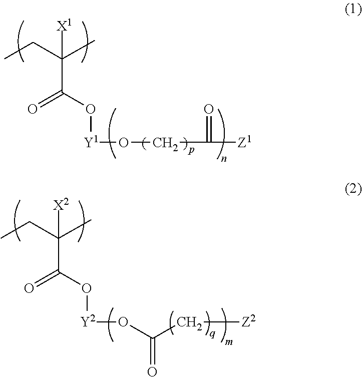
wherein, in Formulae (1) and (2), X¹ and X² each independently represent a hydrogen atom or a monovalent organic group; Y¹ and Y² each independently represent a divalent linking group; Z¹ and Z² each independently represent a monovalent organic group; n and m each independently represent an integer of 1 to 500; and p and q each independently represent an integer of 2 to 5; and when n represents an integer of 2 or more, plural p's may be the same as or different from each other, and when m represents an integer of 2 or more, plural q's may be the same as or different from each other.

6. The light-shielding curable composition according to claim 1, wherein the dispersant having a polyester structure comprises a resin represented by the following Formula (I): 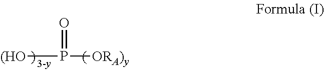
wherein, in Formula (I), R_{A} represents a polyester having a number average molecular weight of from 500 to 30,000; y represents 1 or 2; and when y represents 2, two R_{A}'s may be the same as of different from each other.

7. The light-shielding composition according to claim 1, further comprising an organic pigment.

8. The light-shielding curable composition according to claim 1, wherein a content of the inorganic pigment is from 6% by mass to 70% by mass with respect to a total solid content of the light-shielding curable composition.

9. The light-shielding curable composition according to claim 1, wherein a content of the dispersant having a polyester structure is from 0.1% by mass to 50% by mass with respect to a total solid content of the light-shielding curable composition.

10. The light-shielding curable composition according to claim 1, wherein a content of the polymerizable compound having a polyester structure is from 3% by mass to 55% by mass with respect to a total solid content of the light-shielding curable composition.

11. The light-shielding curable composition according to claim 1, further comprising a binder polymer.

12. A wafer level lens, comprising:
a substrate;
a lens; and
a light-shielding section formed at the circumference of the lens, the light-shielding section being formed by curing the light-shielding curable composition according to claim 1.

13. A color filter, comprising:
a substrate; and
a light-shielding section on the substrate, the light-shielding section being formed by curing the light-shielding curable composition according to claim 1.
